(19) United States
(12) Patent Application Publication
(10) Pub. No.: US 2026/0105892 A1
(43) Pub. Date: Apr. 16, 2026

(54) GATE DRIVING CIRCUIT AND DISPLAY DEVICE INCLUDING THE SAME

(71) Applicant: LG Display Co., Ltd., Seoul (KR)

(72) Inventors: Hwa Young KIM, Gyeonggi-do (KR); Jae Hoon PARK, Gyeonggi-do (KR)

(21) Appl. No.: 19/277,905

(22) Filed: Jul. 23, 2025

(30) Foreign Application Priority Data
Oct. 10, 2024 (KR) 10-2024-0137702

(51) Int. Cl. G09G 3/3266; G09G 3/32

(52) U.S. Cl. CPC G09G 3/3266; G09G 3/32; G09G 2310/0267; G09G 2310/0289; G09G 2330/022

(57) ABSTRACT

A gate driving circuit includes a plurality of cascade-connected signal transmitting parts. An (n)th signal transmitting part includes: a plurality of nodes including: a start signal node to which a start signal or a carry signal from an (n−1)th signal transmitting part is input; a first clock node to which a first clock signal is input; a second clock node to which a second clock signal is input; a circuit including a plurality of transistors and a plurality of capacitors electrically connected to the start signal node, the first clock node, and the second clock node.

### CROSS-REFERENCE TO RELATED APPLICATION

Pursuant to 35 U.S.C. § 119(a), this application claims the benefit of an earlier filing date and right of priority to Korean Patent Application No. 10-2024-0137702, filed in the Republic of Korea on Oct. 10, 2024, the disclosure of which is incorporated herein by reference in its entirety.

### TECHNICAL FIELD

The present disclosure relates to a gate driving circuit and a display device including the same.

### BACKGROUND

With the development of information technology, many related technologies have been developed in the field of display devices for visually displaying information, such as text, images, video, or graphical data. A display device is an output device that converts electrical signals into visible light patterns, typically using an array of pixels composed of sub-pixels.

### SUMMARY

The present disclosure provides a gate driving circuit including an emission driver capable of suppressing inrush current and reducing power consumption, and a display device including the same. However, the objects of the present disclosure are not limited to these objects, and other objects, which are not mentioned herein, will obviously be understood by those skilled in the art from the following description.

According to one example of the present disclosure, a gate driving circuit includes: a plurality of cascade-connected signal transmitting parts to sequentially output an emission signal. An (n)th signal transmitting part includes: a plurality of nodes including: a start signal node to which a start signal or a carry signal from an (n-1)th signal transmitting part is input; a first clock node to which a first clock signal is input; a second clock node to which a second clock signal is input; and a circuit including a plurality of transistors and a plurality of capacitors electrically connected to the start signal node, the first clock node, and the second clock node. During a display non-driving period, the voltages of the start signal node, the first clock node, and the second clock node are maintained at a gate-off voltage. During a display driving period, a plurality of pulses that swing between the gate-off voltage and a gate-on voltage is input to the start signal node, the first clock node, and the second clock node.

The plurality of nodes of the (n)th signal transmitting part may further include: a gate-off voltage node to which the gate-off voltage is applied; an emission-on signal node to which an emission-on signal is input; an output node from which an emission signal is output; and a reset signal node to which a reset signal is input. The voltage of the emission-on signal may be maintained at the gate-off voltage during the display non-driving period, and maintained at the gate-on voltage during the display driving period.

The voltage of the reset signal may be maintained at the gate-on voltage during the display non-driving period, and maintained at the gate-off voltage during the display driving period.

The voltage of the emission signal may be maintained at the gate-off voltage during the display non-driving period. The emission signal may include a plurality of pulses that swing between the gate-off voltage and the gate-on voltage during the display driving period.

The plurality of transistors of the (n)th signal transmitting part may include: a first transistor configured to electrically connect the start signal node to the first N node in response to the gate-on voltage of the second clock signal; a second transistor configured to turn on in response to the gate-on voltage of the emission-on signal; a third transistor configured to electrically connect a first N node to the gate-off voltage node in response to the gate-on voltage on the second QB node; a fourth transistor configured to turn on in response to the gate-on voltage of the second clock signal; a fifth transistor configured to electrically connect a first QB node to the gate-off voltage node in response to the gate-on voltage on the first N node; a sixth transistor configured to electrically connect the emission-on signal node to the output node in response to the gate-on voltage on the Q node; a seventh transistor configured to electrically connect the output node to the gate-off voltage node in response to the gate-on voltage on the first QB node; an eighth transistor configured to electrically connect the first clock node to the second QB node in response to the gate-on voltage on a second N node; a ninth transistor configured to electrically connect the second QB node to the first QB node in response to the gate-on voltage of the first clock signal; and a tenth transistor configured to electrically connect the second QB node to the gate-off voltage node in response to the gate-on voltage on the first N node. A second QB node of the (n-1)th signal transmitting part may be electrically connected to the second N node when the second transistor and the fourth transistor are turned on.

The plurality of transistors of the (n)th signal transmitting part may further include: an eleventh transistor configured to electrically connect the first N node to the Q node in response to a gate-on voltage of the emission-on signal; and a twelfth transistor configured to electrically connect the output node to the gate-off voltage node in response to a gate-on voltage of the reset signal.

The plurality of capacitors of the (n)th signal transmitting part may include: a first capacitor connected between the Q node and the first clock node; a second capacitor connected between the first QB node and the gate-off voltage node; and a third capacitor connected between the second N node and the second QB node.

According to one example of the present disclosure, a display device includes: a display panel including a plurality of pixels, a plurality of gate lines connected to the plurality of pixels, and a gate driving circuit connected to the plurality of gate lines; and a controller configured to: receive a light-emission enable signal; and in response, output a start signal, a first clock signal, a second clock signal, and a masking signal to control the gate driving circuit. Each of the plurality of pixels includes: a light-emitting element; and an emission switch transistor configured to turn on in response to a gate-on voltage of an emission signal to form a current path to the light-emitting element. The gate driving circuit includes: an emission driver including a plurality of cascade-connected signal transmitting parts to sequentially output the emission signal onto each of the plurality of gate lines. An (n)th signal transmitting part of the emission driver includes: a start signal node to which the start signal or a carry signal from an (n-1)th signal transmitting part is input; a first clock node to which a first clock signal is input; a second clock node to which a second clock signal is input; and a circuit including a plurality of transistors and a plurality of capacitors electrically connected to the start signal node, the first clock node, and the second clock node. During a display non-driving period in which the plurality of pixels are not driven, a respective voltage of each of the start signal node, the first clock node, and the second clock node is maintained at a gate-off voltage. During a display driving period in which the plurality of pixels are driven, a respective plurality of pulses that swing between the gate-off voltage and the gate-on voltage is input to each of the start signal node, the first clock node, and the second clock node.

The controller may output an inverse signal of the light-emission enable signal as the masking signal.

The display device may further include: a level shifter configured to level-shift a respective voltage of each of the start signal, the first clock signal, and the second clock signal input from the controller and output it to the emission driver.

The display device may further include: a masking circuit connected between the controller and the level shifter, the masking circuit being configured to: change each of the first clock signal and the second clock signal input from the controller according to the masking signal and output it to the level shifter; and generate a reset signal as an inverse signal of the masking signal and output it to the level shifter.

The level shifter may level-shift a voltage of the reset signal input from the controller to output it to the emission driver, and level-shift a voltage of the masking signal to output an emission-on signal. The emission-on signal may be in phase with the masking signal and has a voltage greater than the masking signal.

The display non-driving period may include a power-on sequence interval, a sleep mode interval, and a power-off sequence interval. The display non-driving period may include at least a portion of the power-on sequence interval.

According to some examples of the present disclosure, a start signal, a first clock signal, and a second clock signal input to an emission driver are controlled by a gate-off voltage during a display non-driving period. As a result, since no pulses are output from the emission driver during the display non-driving period, no power is consumed, and short circuits caused by simultaneously turning on pull-up and pull-down transistors and abnormal shutdown of a power circuit are prevented.

According to some examples of the present disclosure, a reset signal and an emission-on signal related to an emission signal may be additionally masked during the display non-driving period, thereby controlling the voltage of the emission signal to a gate-off voltage even when the emission driver is operating unstably.

According to some examples of the present disclosure, it is possible to efficiently drive the emission driver while suppressing the generation of an inrush current by setting a masking signal during a power-on sequence interval in which the display device is powered on or by setting the masking signal during an initial portion of the power-on sequence interval.

The effects of the present disclosure are not limited to the foregoing effects, and additional effects, which are not mentioned herein, will be obvious to those skilled in the art from the following description.

### BRIEF DESCRIPTION OF THE DRAWINGS

The above and other objects, features, and advantages of the present disclosure will become more apparent to those of ordinary skill in the art by describing examples thereof in detail with reference to the attached drawings, in which:

FIG. 1 is a block diagram illustrating a display device according to one example of the present disclosure;

FIG. 2 is a plan view illustrating a planar arrangement of a display panel according to one example of the present disclosure;

FIG. 3 is a plan view illustrating a planar structure of pixels according to some examples of the present disclosure;

FIG. 4 is a cross-sectional view illustrating a cross-sectional structure of the display panel according to one example of the present disclosure;

FIG. 5 is a diagram illustrating in detail the power flow for driving the display panel according to one example of the present disclosure;

FIG. 6 is a waveform diagram illustrating an example of the enable signal and the input power illustrated in FIG. 5;

FIG. 7 is a plan view illustrating a planar arrangement of a gate driver according to one example of the present disclosure;

FIG. 8 is a diagram illustrating an emission driver according to one example of the present disclosure;

FIG. 9 is a circuit diagram illustrating a pixel circuit of a sub-pixel according to some examples of the present disclosure;

FIG. 10 is a circuit diagram illustrating an example of a pixel circuit of a sub-pixel according to one example of the present disclosure;

FIG. 11 is a waveform diagram illustrating driving signals for the pixel circuit shown in FIG. 10;

FIG. 12 is a circuit diagram illustrating a circuit of an emission driver according to one example of the present disclosure;

FIG. 13 is a waveform diagram illustrating input/output signals and voltages at main nodes for the emission driver shown in FIG. 12;

FIG. 14 is a circuit diagram illustrating a masking circuit according to one example of the present disclosure;

FIG. 15 is a waveform diagram illustrating a method of controlling the emission driver according to one example of the present disclosure;

FIG. 16 is a circuit diagram illustrating an operation of the emission driver during a masking interval according to one example of the present disclosure; and

FIGS. 17 and 18 are waveform diagrams illustrating a method of controlling the emission driver according to other examples of the present disclosure.

### DETAILED DESCRIPTION

The advantages and features of the present disclosure and methods for accomplishing the same will be more clearly understood from the examples described below with reference to the accompanying drawings. However, the present disclosure is not limited to the following examples but may be implemented in various different forms. Rather, the following examples will make the disclosure of the present disclosure complete and allow those of ordinary skill in the art to completely comprehend the scope of the present disclosure.

The shapes, sizes, ratios, angles, numbers, and the like illustrated in the accompanying drawings for describing the following examples of the present disclosure are merely examples, and the present disclosure is not limited thereto. Like reference numerals generally denote like elements throughout the present disclosure. Further, in describing the present disclosure, detailed descriptions of known related technologies may be omitted to avoid unnecessarily obscuring the subject matter of the present disclosure.

The terms such as “comprising,” “including,” “having,” and “containing” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately”or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following examples can be partially or entirely bonded to or combined with each other and can be linked and operated in technically various ways. The following examples can be carried out independently of or in association with each other.

A display device includes a display panel including an array of sub-pixels, a driving circuit for supplying a signal to drive the display panel, a power circuit for supplying power to the display panel, and the like, where the driving circuit includes a gate driving circuit and a data driving circuit for supplying a gate signal and a data signal, respectively, to the display panel.

A gate driving circuit implemented as a GIP (Gate-In-Panel) including a combination of transistors in a bezel area, which is a non-display area of the display panel, may provide one or more emission signals and scan signals (or gate signals), where an emission signal may be used as a gate signal for emitting light from a light-emitting element.

The gate driving circuit, the data driving circuit, and a pixel circuit of the display device may each include a plurality of transistors. For example, each transistor may be implemented as a thin film transistor (TFT). As another example, each transistor may be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In the case of an n-channel transistor, since carriers are electrons, a source voltage is a voltage lower than a drain voltage such that electrons may flow from the source to the drain. The n-channel transistor has a direction of a current flowing from the drain to the source. In the case of a p-channel transistor, since carriers are holes, a source voltage is higher than a drain voltage such that holes may flow from the source to the drain. In the p-channel transistor, since holes flow from the source to the drain, current flows from the source to the drain. It should be noted that a source and a drain of a transistor are not fixed. For example, a source and a drain may be changed according to an applied voltage. Therefore, the present disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various examples of the present disclosure will be described in detail with reference to the accompanying drawings.

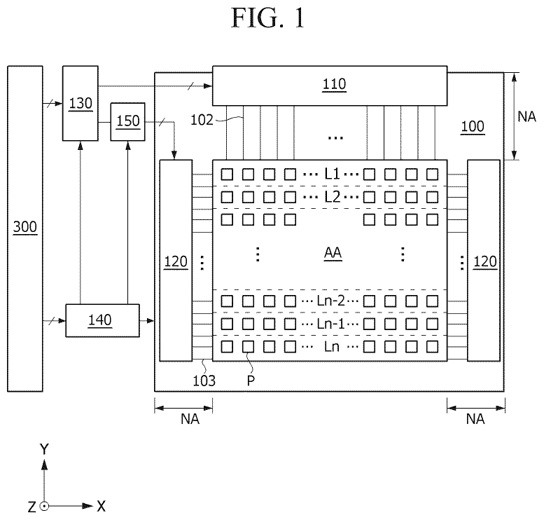

FIG. 1 is a block diagram illustrating a display device according to one example of the present disclosure.

Referring to FIG. 1, the display device includes a display panel 100, display panel driving circuits 110 and 120 for writing image data to pixels P of the display panel 100, and a power circuit 140 for generating power involved for driving the pixels P and the display panel driving circuits 110 and 120.

The display panel driving circuits 110 and 120 include a data driving circuit 110 and a gate driving circuit 120. For ease of description, the data driving circuit 110 will also be referred to as a data driver, and the gate driving circuit 120 will also be referred to as a gate driver. For example, the display panel driving circuits 110 and 120 and the power circuit 140 may be implemented as a display panel driver that drives the display panel 100.

The display panel 100 may be a panel having a rectangular structure with a length in the X-axis direction, a width in the Y-axis direction, and a thickness in the Z-axis direction. The display panel 100 may be implemented as a non-transmissive display panel or a transmissive display panel. The transmissive display panel may be employed in a transparent display device that displays images on the screen and show the real objects in the background outside the display panel. The display panel 100 may be implemented as a flexible display panel.

A display area AA of the display panel 100 may include a pixel array for displaying images thereon. The pixel array may include a plurality of data lines 102, a plurality of gate lines 103 intersecting the data lines 102, and the pixels P arranged in a matrix form. The display panel 100 may further include power wires commonly connected to the pixels P. The power wires may include, but are not limited to, power wires connected to the pixels P to supply the pixels P with a constant voltage necessary to drive the pixels P, and power wires to supply the pixels P with a reference voltage.

The pixels P may be divided into two or more sub-pixel circuits for color implementation. For example, three pixels, which are arranged sequentially along the X-axis direction, may be divided into a red sub-pixel, a green sub-pixel, and a blue sub-pixel. In another example, four pixels, which are arranged sequentially along the X-axis direction, may be divided into a red sub-pixel, a green sub-pixel, a blue sub-pixel, and a white sub-pixel. Each of the pixels may be connected to the data line, the gate lines, and the power wires.

The pixel array may include a plurality of pixel lines L1 to Ln. Each of the pixel lines L1 to Ln may include one line of the pixels P arranged along the line direction (X-axis direction) in the pixel array of the display panel 100. The pixels P arranged in one pixel line may share the gate lines (GL) 103. The pixels P arranged in a column direction (Y-axis direction) along the direction of the data lines may share the same data lines 102 and the same sensing lines 104. One horizontal period is a time obtained by dividing one frame period by the total number of the pixel lines L1 to Ln.

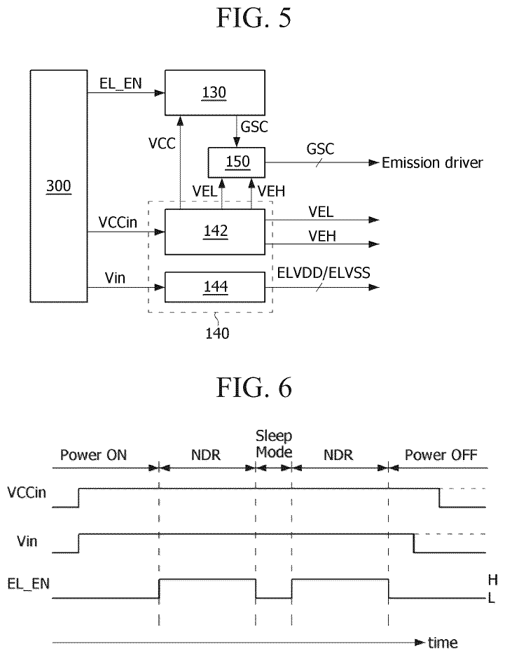

A timing controller 130 may receive pixel data of an input image and a timing signal synchronized with the pixel data from a host system 300. The timing signal may include a vertical synchronization signal Vsync, a horizontal synchronization signal Hsync, a main clock CLK, and a data enable signal DE. One cycle of the vertical synchronization signal Vsync may be a period of one frame. One cycle of the horizontal synchronization signal Hsync and the data enable signal DE may be one horizontal period 1 H. The pulse of the data enable signal DE may be synchronized with one line of data to be written to the pixels P on one pixel line. Since a frame period and a horizontal period may be known by counting the data enable signal DE, the vertical synchronization signal Vsync and the horizontal synchronization signal Hsync may be omitted. The timing controller 130 may transmit the pixel data of the input image to the data driver 110 and control the operation timing of the data driver 110 and the gate driver 120. A gate timing control signal (GSC in FIG. 5) generated from the timing controller 130 may be inputted to the gate driver 120 through a level shifter 150. The gate timing control signal GSC may include a start signal, a clock signal, and a masking signal.

The timing controller 130 may receive a light-emission enable signal EL_EN from the host system 300 and control the gate driver 120 according thereto in response.

The level shifter 150 may receive the gate timing control signal and output a gate timing signal such as the start signal, the clock signal, and the masking signal. An input signal to the level shifter 150 may be a signal of a digital signal voltage level, and an output signal from the level shifter 150 may be an analog voltage signal that swings between the gate high voltage and the gate low voltage. The level shifter 150 may convert a low level voltage of the gate timing signal output from the timing controller 130 into a gate low voltage and a high level voltage into a gate high voltage.

The data driver 110 may receive the pixel data of the input image as a digital signal from the timing controller 130 and output a data voltage. The data driver 110 may convert the pixel data of the input image into a gamma compensated voltage using a digital-to-analog converter (DAC) and output the data voltage. A gamma reference voltage output from the power circuit 140 may be divided into the gamma compensated voltage for each grayscale by a voltage divider circuit in the data driver 110 and supplied to the DAC. The DAC may generate the data voltage as the gamma compensated voltages corresponding to grayscale values of the pixel data. The data voltages output from the DAC may be output to the data lines 102 through output buffers from the respective channels of the data driver 110.

The gate driver 120 may be arranged on the display panel 100. The gate driver 120 may be arranged in the non-display area NA outside the display area AA in the display panel 100, or at least a portion thereof may be arranged in the display area AA. The gate driver 120 may supply gate signals to the gate lines GL in a single feeding method. In the single feeding method, the gate signals may be applied to one respective end of each of the gate lines GL. In a double feeding method, the gate signals may be applied simultaneously to opposite respective ends of each of the gate lines GL. The gate signals output from the gate driver 120 may be applied to the pixels P of the display area AA.

If a plurality of gate signals is applied to each of the pixels P, the gate driver 120 may include a plurality of gate drivers that output different gate signals. The gate driver 120 may include circuits such as a shift register, an edge trigger, and the like to shift the pulses of the gate signals.

The power circuit 140 may include, but is not limited to, a charge pump, a regulator, a buck converter, a boost converter, and the like. The power circuit 140 may receive a direct current input voltage from the host system 300 to generate the power involved to drive the driving circuits 110 and 120 of the display panel 100 and the pixels P of the display panel 100. The power circuit 140 may output a constant voltage (or DC voltage), such as the gamma reference voltage, the gate high voltage, the gate low voltage, etc. In addition, the power circuit 140 may output a constant voltage to be provided to the pixels P. The gamma reference voltage may be supplied to the data driver 110. The gate high voltage and the gate low voltage may be supplied to the level shifter 150 and the gate driver 120.

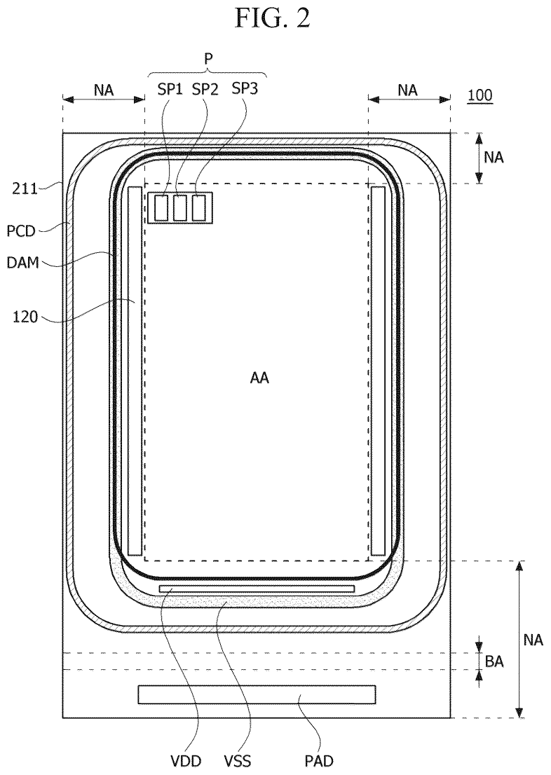

FIG. 2 is a plan view illustrating a planar arrangement of the display panel 100 according to one example of the present disclosure. The planar structure of the display panel 100 is not limited to the structure shown in FIG. 2.

Referring to FIG. 2, the display area AA may be an area in which a plurality of pixels P are arranged to display an image. On a substrate 211 of the display panel 100, a non-display area NA may be located outside the display area AA such that it is adjacent to the display area AA.

The pixel P may further include a plurality of sub-pixels SP1, SP2, and SP3. Example shapes of the first sub-pixel SP1, the second sub-pixel SP2, and the third sub-pixel SP3 may be, but are not limited to, rectangular, pentagonal, hexagonal, octagonal, circular, oval, and the like. The first sub-pixel SP1, the second sub-pixel SP2, and the third sub-pixel SP3 may emit different colors of light, and the first sub-pixel SP1, the second sub-pixel SP2, and the third sub-pixel SP3 may emit at least one of red, green, or blue. The third sub-pixel SP3 may have a larger area than the other sub-pixels. The third sub-pixel SP3 may be arranged across other sub-pixels.

Each of the sub-pixels SP1, SP2, and SP3 may include transistors and capacitors of a pixel circuit for driving a light-emitting element. For example, each of the sub-pixels SP1, SP2, and SP3 may be implemented with two transistors and one capacitor (2T1C), but may also be implemented as sub-pixels with 3T1C, 4T1C, 5T1C, 6T1C, 7T1C, 3T2C, 4T2C, 5T2C, 6T2C, 7T2C, 8T2C, etc. Here, ‘T’ denotes a transistor and ‘C’ denotes a capacitor. The light-emitting element may be an organic light-emitting element, such as an OLED, or an inorganic light-emitting element, such as a micro LED.

The display area AA and the non-display area NA may have any shape suitable for the design of the electronic device with the display panel 100 mounted thereon. If the display device is on a user-wearable device, it may have a circular shape, such as a common wristwatch, and the concepts of examples of the present disclosure may also apply to free-form displays, such as those found in a vehicle dashboard or the like. An example shape of the display area AA may be, but is not limited to, pentagonal, hexagonal, circular, oval, etc.

The display panel 100 may also include additional elements in addition to the function for driving the sub-pixels SP1, SP2, and SP3. For example, the display panel 100 may include additional elements that provide a touch sensing function, a user authentication function (e.g., face and fingerprint recognition), a multi-level pressure sensing function, a tactile feedback function, and the like. The aforementioned additional elements may be located in the non-display area NA or in an external circuit connected through a connection interface.

A pad part PAD may be located at one side of the non-display area NA. The pad part PAD may be a metal pattern to which external modules, such as flexible printed circuit boards (FPCB) and chip on films (COF), are bonded. While the pad part PAD is shown to be located at one side of the substrate 211, the shape and location of the pad part is not limited thereto.

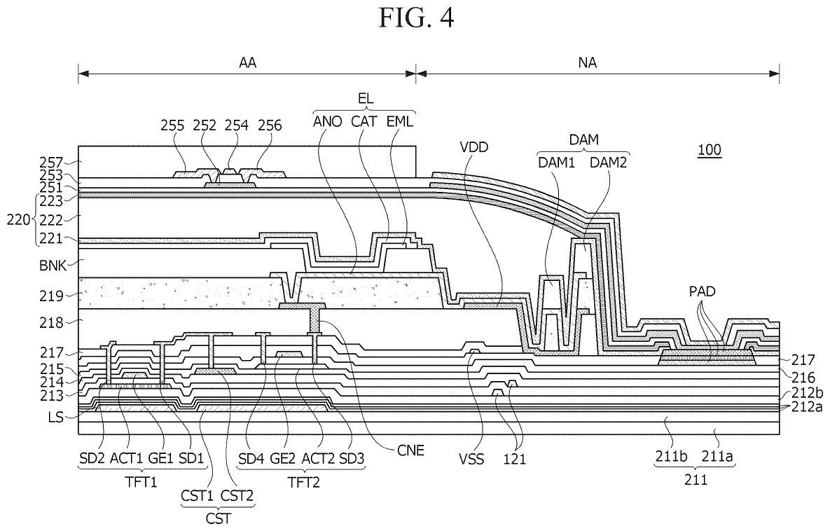

A dam DAM may be located in the non-display area NA to surround the entirety or a portion of the display area AA. The dam DAM may be adjacent to the display area AA and may be located outside of the display area AA. The dam DAM may be arranged along the periphery of the display area AA to suppress the flow of the organic material layer in an encapsulation layer arranged on a light-emitting element layer. The dam DAM may include a plurality of dams DAM1 and DAM2 as shown in FIG. 4.

The data driver 110 may be located in the non-display area NA. The power wires, a multiplexer, an antistatic circuit, and a plurality of connection wire parts may be arranged between the display area AA and the data driver 110. These components may be placed between the display area AA and a bending area BA. The power wires may include a VDD wire VDD and a VSS wire (VSS) arranged in the non-display area NA. The VDD wire VDD may include a VDD shorting bar connected to the power wires PL to which the pixel driving voltage ELVDD is applied. A pixel ground voltage ELVSS or a ground voltage GND is applied to the VSS wire VSS. The VSS wire VSS may be connected to the cathode electrodes (CAT in FIG. 4) of the pixels P. The wires 121 connected to the gate driver 120 may be arranged in the non-display area NA.

A connection wire part may be located in the non-display area NA. For example, it may be located in the bending area BA, in which the substrate is bent, in the non-display area NA. The connection wire part may include wires to pass signals (voltage) from an external module bonded to the pad part to the display area AA or to the driving circuits such as the gate driver 120 and the data driver 110.

A panel crack detector PCD may further arranged in the non-display area NA of the substrate 211. The panel crack detector PCD may be used as a sensor pattern to detect crack failures that may occur and propagate from the perimeter of the display panel 100. The panel crack detector PCD may be arranged in a ring pattern between the outermost end of the substrate 211 and the dam DAM. The panel crack detector PCD may be located downstream of the dam DAM and may at least partially overlap the DAM. A selected crack detection voltage, such as a ground voltage GND or a constant voltage, may be provided to the panel crack detector PCD by the data driver 110 or the power circuit 140.

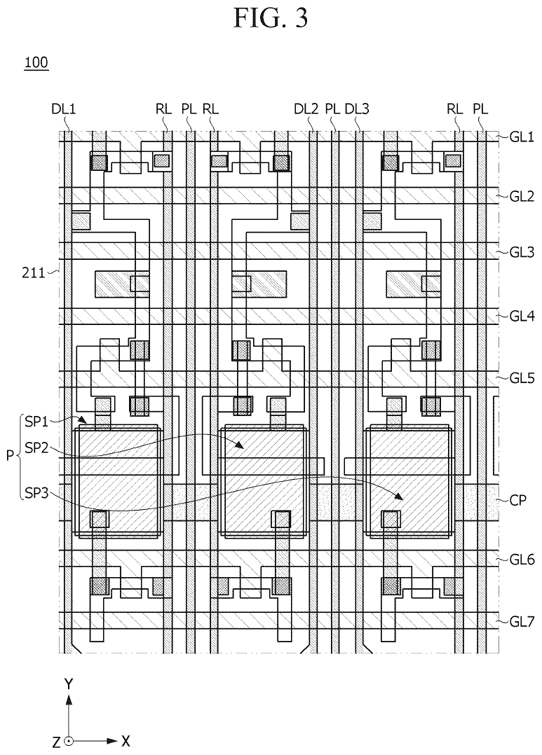

FIG. 3 is a plan view illustrating a planar structure of the pixels P of the display area AA according to some examples of the present disclosure.

Referring to FIG. 3, data lines DL1, DL2, and DL3 may be arranged on the display area AA to extend in the Y-axis direction. Power wires PL and RL may be arranged at least partially in parallel with the data lines DL1, DL2, and DL3. The power wire PL supplies the pixel driving voltage ELVDD to the pixels P, and the power wire RL supplies the reference voltage to the pixels P. The power wire RL may be used as a wire for sensing the electrical characteristics of the transistors and/or light-emitting elements of the sub-pixel, for example, threshold voltage, mobility, etc. A plurality of sub-pixels may share the power wires PL and RL. The gate lines GL1 to GL7 extend in the X-axis direction and intersect with the data lines DL1, DL2, and DL3 and power wires PL and RL.

FIG. 4 is a cross-sectional view illustrating a cross-sectional structure of the display panel 100 according to one example of the present disclosure. The cross-sectional structure of the display panel 100 is not limited to the structure shown in FIG. 4.

Referring to FIG. 4, the display panel 100 may include a circuit layer, a light-emitting element layer arranged on the circuit layer, and an encapsulation layer 220 arranged over the light-emitting element layer, when viewed in cross-sectional structure. Touch sensors may be arranged on the encapsulation layer.

The pixel P may include a light-emitting element EL and a pixel circuit that applies a driving current to the light-emitting element EL. The pixel circuit is arranged in the circuit layer on the substrate 211 and is electrically connected to the light-emitting element EL. The light-emitting element EL may be arranged in the light-emitting element layer. The encapsulation layer 220 may cover the light-emitting element EL to protect the light-emitting element EL.

The transistors constituting the pixel circuit may be implemented as one or more of an Oxide TFT (Thin Film Transistor), including oxide semiconductors, and an LTPS (Low Temperature Poly Silicon) TFT, including LTPS. Oxide TFTs have excellent leakage current blocking effect and are relatively inexpensive to manufacture compared to LTPS TFTs. In some examples, all of the transistors constituting the pixel circuit may be implemented with oxide TFTs, and only some of the switching transistors may be implemented with oxide TFTs.

The LTPS TFTs are fast in operation and have excellent reliability. The transistors of the pixel circuit may be configured as a combination of oxide TFTs and LTPS TFTs in consideration of their functions and power consumption. In FIG. 4, one of the first transistor TFT1 and the second transistor TFT2 may be an oxide TFT, and the other may be an LTPS TFT.

The substrate 211 may be multi-layered substrates 211a and 211b in which an organic layer and an inorganic layer are alternately stacked. For example, the substrate 211 may be stacked with an organic film, such as polyimide, and an inorganic film, such as silicon oxide (SiO₂), alternating with each other.

A lower buffer layer 212a may be formed on the substrate 211. The lower buffer layer 212a may be formed by stacking a silicon oxide (SiO₂) layer or the like in multiple layers to block moisture or the like that may penetrate from an external environment. An auxiliary buffer layer 212b may be further located on the lower buffer layer 212a to protect the device from moisture penetration.

A first transistor TFT1 may be formed on the substrate 211. The first transistor TFT1 may include a first active layer ACT1 including a channel through which electrons or holes move, a gate electrode GE1, a first electrode SD1, and a second electrode SD2. The first active layer ACT1 may be implemented with a polycrystalline semiconductor material. The first active layer ACT1 may include a channel region, a first source region located at one side of the channel region, and a first drain region located at the other side of the channel region. The first source region and the first drain region are regions obtained by doping an intrinsic polycrystalline semiconductor material to be conductive with an impurity ion of Group 5 or Group 3, for example phosphorus (P) or boron (B), at a predetermined concentration. The first channel region, in which the polycrystalline semiconductor material maintains its intrinsic state, may provide a path for the movement of electrons or holes.

The gate electrode GE1 of the first transistor TFT1 overlaps the channel region of the first active layer ACT1. A first gate insulating layer 213 may be arranged between the gate electrode GE1 and the first active layer ACT1. The first gate insulating layer 213 may be formed by stacking an inorganic layer of silicon oxide (SiO₂), silicon nitride (SiNx), or the like in a single layer or multiple layers.

A first electrode CST1 of a capacitor CST and a light shielding layer LS under the first transistor TFT1 may be formed of the same material as the gate electrode GE1. The light shielding layer LS may be formed under any transistor, not limited to the first transistor TFT1. The light shielding layer LS may be placed on the lower portion of the capacitor CST to form a double capacitor.

When the substrate 211 is formed of a transparent material, the light shielding layer LS may be formed under the active layers ACT1 and ACT2. The light shielding layer LS may block light that passes through the transparent substrate 211 and is directed to the active layers ACT1 and ACT2. The light shielding layer LS may be electrically connected to the gate electrode GE1 to form a dual gate. The light shielding layer LS may be formed on the lower buffer layer 212a or on the auxiliary buffer layer 212b.

The gate electrode GE1 may include a metallic material. For example, the gate electrode GE1 may be a single layer or a multilayer made of any one of, but is not limited to, molybdenum (Mo), aluminum (Al), chromium (Cr), gold (Au), titanium (Ti), nickel (Ni), neodymium (Nd), and copper (Cu), or an alloy thereof.

A first interlayer insulating layer 214 may be arranged on the gate electrode GE1. The first interlayer insulating layer 214 may be implemented with silicon oxide (SiO₂), silicon nitride (SiNx), or the like. The display panel 100 may further include an upper buffer layer 215, a second gate insulating layer 216, and a second interlayer insulating layer 217 sequentially arranged on the first interlayer insulating layer 214.

A second transistor TFT2 may be formed on the upper buffer layer 215 and may include a second active layer ACT2 implemented with an oxide semiconductor material, a gate electrode GE2 arranged on the second gate insulating layer 216, a first electrode SD3 and a second electrode SD4 arranged on the second interlayer insulating layer 217.

The first electrode SD3 and the second electrode SD4 may be a single layer or a multilayer made of any one of, but is not limited to, molybdenum (Mo), aluminum (Al), chromium (Cr), gold (Au), titanium (Ti), nickel (Ni), neodymium (Nd), and copper (Cu), or an alloy thereof.

The upper buffer layer 215 may separate the second active layer ACT2 implemented with the oxide semiconductor material from the first active layer ACT1 implemented with the polycrystalline semiconductor material, and provide a base for forming the second active layer ACT2. The second gate insulating layer 216 covers the second active layer ACT2 of the second transistor TFT2. The second gate insulating layer 216 may be formed over the second active layer ACT2, which may be implemented as an oxide semiconductor material, and may therefore be implemented as an inorganic film. For example, the second gate insulating layer 216 may be silicon oxide (SiO₂), silicon nitride (SiNx), or the like.

The gate electrode GE2 may include a metallic material. For example, the gate electrode GE2 may be a single layer or a multi-layer made of any one of, but is not limited to, molybdenum (Mo), aluminum (Al), chromium (Cr), gold (Au), titanium (Ti), nickel (Ni), neodymium (Nd), and copper (Cu), or an alloy thereof.

The second active layer ACT2 may be implemented with an oxide semiconductor material, and may include an intrinsic second channel region that is not doped with impurities, and a second source region and a second drain region that are doped with impurities to be conductive.

In some implementations, the capacitor CST may be implemented by arranging the second electrode CST2 on the first interlayer insulating layer 214 to overlap the first electrode CST1. For example, the second electrode CST2 may be a single layer or a multi-layer made of any one of, but is not limited to, molybdenum (Mo), aluminum (Al), chromium (Cr), gold (Au), titanium (Ti), nickel (Ni), neodymium (Nd), and copper (Cu), or an alloy thereof.

The capacitor CST may include two electrodes corresponding to each other and a dielectric disposed therebetween. The first interlayer insulating layer 214 may be located between the first electrode CST1 and the second electrode CST2. The first electrode CST1 or the second electrode CST2 may be electrically connected to the electrodes of one or more transistors TFT1 and TFT2.

A first planarization layer 218 and a second planarization layer 219 may be stacked to planarize the surface of the circuit layer. The first planarization layer 218 and the second planarization layer 219 may be an organic film, such as a polyimide or acrylic resin. A light-emitting element layer including a light-emitting element EL may be disposed over the second planarization layer 219.

The light-emitting element EL may include an anode electrode ANO, a cathode electrode CAT, and an emission layer EML arranged between the anode electrode ANO and the cathode electrode CAT. The light-emitting element EL may be electrically connected to a transistor of the pixel circuit, such as the second transistor TFT2, via an intermediate electrode CNE arranged on the first planarization layer 218. The anode electrode ANO may be connected to the intermediate electrode CNE exposed through a contact hole penetrating the second planarization layer 219. The intermediate electrode CNE may be connected to the first electrode SD3 exposed through a contact hole penetrating the first planarization layer 218. The intermediate electrode CNE may be formed of a conductive material such as copper (Cu), silver (Ag), molybdenum (Mo), or titanium (Ti).

The anode electrode ANO may be formed as a multi-layer structure including a transparent conductive film and an opaque conductive film with high reflective efficiency. The transparent conductive film may be made of material having a relatively large work function value, such as indium-tin-oxide (ITO) or indium-zinc-oxide (IZO), and the opaque conductive films may be formed as a single layer structure or a multi-layer structure containing aluminum (Al), silver (Ag), copper (Cu), lead (Pb), molybdenum (Mo), titanium (Ti), or alloys thereof. The anode electrode ANO may be formed as a structure in which a transparent conductive film, an opaque conductive film, and a transparent conductive film are sequentially stacked, or may be formed as a structure in which a transparent conductive film and an opaque conductive film are sequentially stacked. The emission layer EML may be formed by stacking a hole-related layer, an organic emission layer, and an electron-related layer on the anode electrode ANO in the order of or in the reverse order thereof.

A bank layer BNK may be a pixel defining film that exposes the anode electrode ANO of each pixel P. The bank layer BNK may also be formed of an opaque material (e.g., black) to prevent light interference between neighboring pixels P. In this case, the bank layer BNK may include a light shielding material made of at least one of color pigment, organic black, and carbon. A spacer may be further arranged on the bank layer BNK.

The cathode electrode CAT may face the anode electrode ANO with the emission layer EML interposed therebetween and may be formed on the upper surface and the side surface of the emission layer EML. The cathode electrode CAT may be integrally formed over the entire display area AA. In the case of a top emission type organic light-emitting display device, the cathode electrode CAT may be formed of a transparent conductive layer such as indium-tin-oxide (ITO) or indium-zinc-oxide (IZO).

An encapsulation layer 220 covers the light-emitting element EL to prevent moisture penetration that could adversely affect the light-emitting element EL. The encapsulation layer 220 may include, but is not limited to, at least one inorganic encapsulation layer and at least one organic encapsulation layer. A structure of the encapsulation layer 220 in which a first encapsulation layer 221, a second encapsulation layer 222, and a third encapsulation layer 223 are sequentially stacked is described as an example.

The first encapsulation layer 221 may cover the cathode electrode CAT, and the third encapsulation layer 223 may be formed on the second encapsulation layer 222. The first encapsulation layer 221 and the third encapsulation layer 223 may minimize or prevent external moisture or oxygen from penetrating into the light-emitting element EL. The first encapsulation layer 221 and the third encapsulation layer 223 may be formed of an inorganic insulating material capable of low temperature deposition, such as silicon nitride (SiNx), silicon oxide (SiOx), silicon oxynitride (SiON), or aluminum oxide (Al₂O₃). Since the first encapsulation layer 221 and the third encapsulation layer 223 are deposited in a low-temperature atmosphere, the deposition process of the first encapsulation layer 221 and the third encapsulation layer 223 may prevent damage to the light-emitting element EL, which is vulnerable to a high-temperature atmosphere.

The second encapsulation layer 222 may serve as a buffer to relieve stress between layers due to the bending of the display device 10, and may planarize the step difference between the layers. This second encapsulation layer 222 may be formed of, but is not limited to, acrylic resin, epoxy resin, phenolic resin, polyamide resin, polyimide resin, and a non-sensitive organic insulating material such as polyethylene or silicon oxycarbon (SiOC) or a photosensitive organic insulating material such as photoacrylic on the substrate 211 on which the first encapsulation layer 221 is formed. When the second encapsulation layer 222 is formed using an inkjet method, a dam DAM may be arranged to prevent the liquid form of the second encapsulation layer 222 from spreading into the edges of the substrate 211. The dam DAM may be arranged closer to the edge of the substrate 211 than the second encapsulation layer 222. The dam DAM may prevent the second encapsulation layer 222 from spreading into the pad area in which the conductive pad is located at the outermost edge of the substrate 211.

The dam DAM may be designed to prevent the spread of the second encapsulation layer 222, but when the second encapsulation layer 222 is formed to exceed the height of the dam DAM during the process, the second encapsulation layer 222, which is an organic layer, may be exposed to the outside, so that moisture or the like may easily penetrate into the light-emitting element. To prevent this, the dam DAM may be formed of at least 10 or more stacked insulating patterns.

The dam DAM may be arranged on the second interlayer insulating layer 217 of the non-display area NA. The dam DAM may be formed simultaneously with the first planarization layer 218 and the second planarization layer 219. When the first planarization layer 218 is formed, a lower layer of the dam DAM is formed together, and when the second planarization layer 219 is formed, an upper layer of the dam DAM is formed together, so that the dam DAM may be stacked in a double structure. The dam DAM may be formed of the same material as the first planarization layer 218 and the second planarization layer 219, but is not limited thereto.

The dam DAM may overlap the VSS wire VSS shown in FIG. 2 in the thickness direction Z of the display panel 100. For example, the VSS wire VSS may be formed in the lower layer of the area where the dam DAM is located in the non-display area NDA. The VSS wire VSS is formed around the perimeter of the display panel 100. The VSS wire VSS may be made of, but is not limited to, the same material as the gate electrode GE1.

A touch sensor layer may be arranged on the encapsulation layer. A touch buffer film 251 in the touch sensor layer may be located between the touch sensor metal including touch electrode connection lines 252, 254 and touch electrodes 255, 256, and the cathode electrode CAT of the light-emitting element EL.

The touch buffer film 251 may block penetration a chemical liquid (such as a developer or an etchant) or moisture from the outside used in a manufacturing process of a touch sensor arranged on the touch buffer film 251 into the light-emitting element layer. The touch buffer film 251 may prevent damage to the emission layer EML that is vulnerable to chemical liquid or moisture.

The touch buffer film 251 may be formed of an organic insulating material that can be formed at a certain temperature, e.g., 100° C. or lower, and has a low dielectric constant of 1 to 3 in order to prevent damage to the emission layer EML, which includes an organic material vulnerable to high temperatures. For example, the touch buffer film 251 may be formed of an acrylic, epoxy, or siloxan-based material. The touch buffer film 251, which is an organic insulating material and has a planarizing property, may prevent damage to the encapsulation layer 220 and breakage of the touch sensor when the display panel 100 is bent.

In the case of a mutual-capacitance based touch sensor, touch electrodes 254, 255, and 256 are arranged on the touch buffer film 251, wherein the touch electrodes 254, 255, and 256 may be connected to the wires to cross each other.

The touch electrode connection line 252 may connect the touch electrodes 255 and 256 in one direction separated from the intersection between the touch electrode wires. The touch electrode connection line 252 and the touch electrodes 255 and 256 may be located on different layers with a touch insulating film 253 interposed between them to overlap each other. The touch electrode connection line 252 may be arranged to overlap bank layer BNK, thereby preventing a decrease in the aperture ratio. The wires to which the touch electrodes 254, 255, and 256 are connected may be electrically connected through a touch pad part PAD to a touch driving circuit not shown in the drawing.

A touch protection film 257 may cover the touch electrodes 254, 255, and 256. Although the touch protection film 257 is shown to be arranged only on the touch electrodes 254, 255, and 256, the touch protection film 257 may extend to before or after the dam DAM and may also be arranged on the touch electrode connection line 252.

A color filter (not shown) may be further arranged on the encapsulation layer 220, wherein the color filter may be located on the touch sensor layer, or may be located between the encapsulation layer 220 and the touch sensor layer.

FIG. 5 is a diagram illustrating in detail the power flow for driving the display panel 100. FIG. 6 is a waveform diagram illustrating an example of the enable signal and the input power illustrated in FIG. 5.

Referring to FIGS. 5 and 6, the host system 300 provides a light-emission enable signal EL_EN to the timing controller 130 and input voltages VCCin and Vin to the power circuit 140. VCCin may be 3.3V and Vin may be 12V, but are not limited thereto.

The power circuit 140 may be implemented with a first power IC 142 and a second power IC 144. The first power IC 142 may be a power management integrated circuit (PMIC), and the second power IC 144 may be an electronics integrated circuit (ELIC), but are not limited thereto. The first power IC 142 may receive a first input voltage VCCin and output an IC driving power VCC (1.8V) for the timing controller 130, the gate low voltage VEL (−6V) for the emission signal, and the gate high voltage VEH (6V) for the emission signal. The second power IC 144 may receive a second input voltage Vin and output a pixel driving voltage ELVDD and a pixel ground voltage ELVSS.

Referring to FIG. 6, the host system 300 may output the light-emission enable signal EL_EN for controlling the on/off emission of pixels. The light-emission enable signal EL_EN is generated as a first logic value to indicate the light-emission of the pixels P during the display driving period NDR during which the pixels are driven so that the input image is reproduced on the display area AA of the display panel 100. On the other hand, the host system 300 outputs the light-emission enable signal EL_EN as a second logic value during a display non-driving period in which the pixels are not driven, such as during the power-on sequence interval Power ON, sleep mode interval Sleep Mode, and power-off sequence interval Power OFF. The first logic value may be a high level voltage (H) and the second logic voltage may be a low level voltage (L), but are not limited thereto. The timing controller 130 may control the start signal and the clock signal provided to an emission driver in response to the light-emission enable signal EL_EN.

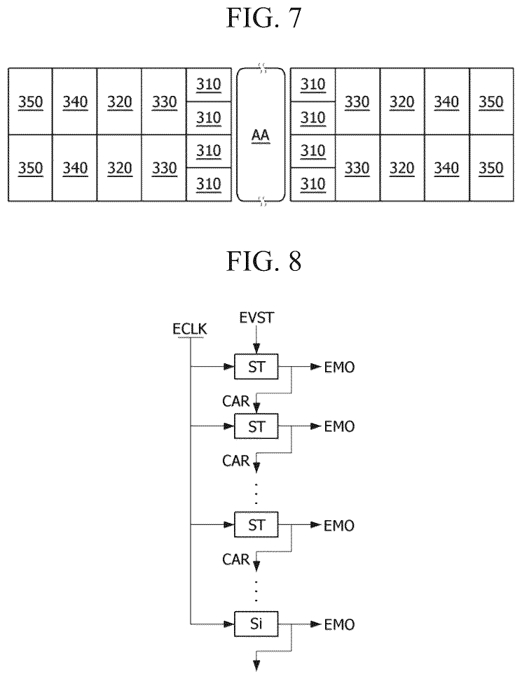

FIG. 7 is a plan view illustrating a planar arrangement of the gate driver 120 according to one example of the present disclosure. The gate driver 120 is not limited to FIG. 7.

Referring to FIG. 7, a plurality of gate signals may be applied to the pixels. For example, the gate signals may include a first gate signal SC1, a second gate signal SC2, a third gate signal SC3, a fourth gate signal EM1, and a fifth gate signal EM2. Each of the gate signals SC1, SC2, SC3, EM1, and EM2 may be shifted in a unit of horizontal periods. Hereinafter, the first, second, and third gate signals SC1, SC2, and SC3 will be referred to as “scan signals” and the fourth and fifth gate signals EM1 and EM2 will be referred to as “emission signals”. The emission signals EM1 and EM2 may be changed to a single emission signal. The emission signal is the control signal for the transistor that conducts the current path between the pixel driving voltage ELVDD and the pixel ground voltage ELVSS.

The gate driver 120 may include a first scan driver 310 sequentially outputting the first scan signal SC1, a second scan driver 320 sequentially outputting the second scan signal SC2, a third scan driver 330 sequentially outputting the third scan signal SC3, a first emission driver 340 sequentially outputting the first emission signal EM1, and a second emission driver 350 sequentially outputting the second emission signal EM2.

Some of the plurality of the gate drivers may be implemented with shift register circuits and the remainder may be implemented with edge trigger circuits. For example, the first scan driver 310 may be implemented as a shift register circuit, and the other scan drivers 320, 330 and the emission drivers 340, 350 may be implemented as edge triggers, but are not limited thereto. A shift register may output a gate signal to a single pixel line. An edge trigger may output a gate signal common to two pixel lines. For example, the first scan driver 310 may be implemented with a shift register connected to each of the odd-numbered pixel line and the even-numbered pixel line. The second and third scan drivers 320 and 330 and the first and second emission driver 340 and 350 may be implemented with edge triggers common to two neighboring pixel lines. The pulses of the scan signals and emission signals are output from the gate drivers according to the start pulse and the clock input to the corresponding gate drivers.

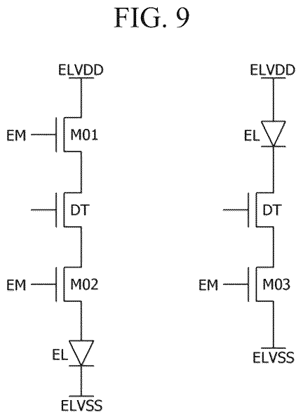

FIG. 8 is a diagram illustrating an emission driver according to one example of the present disclosure. Each of the first and second emission drivers 340 and 350 may be configured according to the emission driver of FIG. 8.

Referring to FIG. 8, the emission driver includes a plurality of signal transmitting parts ST cascade-connected to one another. The signal transmitting parts may be interpreted as stages. A first signal transmitting part ST receives a start pulse EVST and a clock signal ECLK and outputs a pulse of an emission signal EMO. The signal transmitting parts ST cascade-connected to the first signal transmitting part ST receive a carry signal CAR and a clock signal ECLK input from their previous signal transmission parts and sequentially output the pulse of the emission signal EMO. The emission signal EMO controls the on/off of an emission switch elements arranged in the pixel circuits of the sub-pixels SP1, SP2, and SP3.

FIG. 9 is a circuit diagram illustrating a pixel circuit of a sub-pixel SP according to some examples of the present disclosure.

Referring to FIG. 9, the pixel circuit includes a light-emitting element EL, a driving element DT for driving the light-emitting element EL, and one or more emission switch elements M01, M02, and M03. The driving element DT and the emission switch elements M01, M02, and M03 may be implemented with transistors. In FIG. 9, the transistors are illustrated as an n-channel transistor, but is not limited thereto.

The driving element DT generates a current according to the gate-source voltage Vgs to drive the light-emitting element EL. The emission switch elements M01, M02, and M03 may be connected to opposite sides of the driving element DT or connected to one side thereof. The emission switch elements M01, M02, and M03 form or block the current path flowing to the light-emitting element EL in response to the gate-on voltage of the emission signal EM between the pixel driving voltage ELVDD and the pixel ground voltage ELVSS.

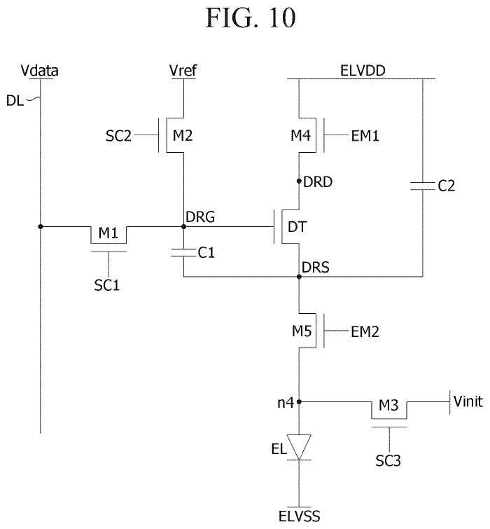

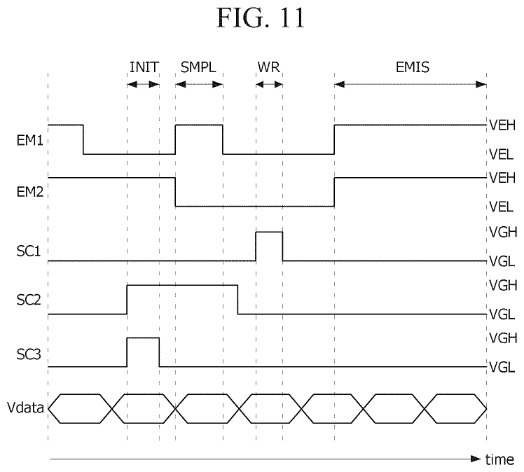

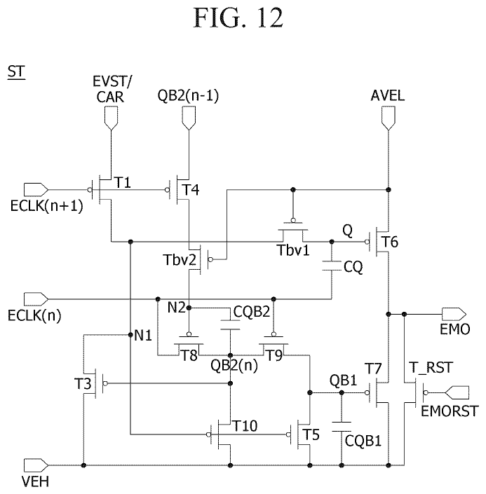

FIG. 10 is a circuit diagram illustrating an example of a pixel circuit of a sub-pixel SP according to one example of the present disclosure. FIG. 11 is a waveform diagram illustrating driving signals for the pixel circuit shown in FIG. 10.

Referring to FIGS. 10 and 11, the pixel circuit includes a light-emitting element EL, a driving element DT that supply a current to the light-emitting element EL, a plurality of switch elements M1 to M5, a first capacitor C1, and a second capacitor C2. The driving element DT and the switch elements M1, M2, M3, M4, and M5 may be implemented with, but not limited to, n-channel transistors.

Constant voltages such as a pixel driving voltage ELVDD, a pixel ground voltage ELVSS, a reference voltage Vref, an initialization voltage Vinit, and the like may be applied to the pixel circuit. These constant voltages ELVDD, ELVSS, Vref, and Vinit may be output from the power circuit 140. The pixel driving voltage ELVDD may be higher than the pixel ground voltage ELVSS. A gate high voltage VGH, VEH may be set to a voltage higher than the pixel driving voltage ELVDD. A gate low voltage VGL, VEL may be set to a voltage lower than the pixel ground voltage ELVDD.

The initialization voltage Vinit may be set to a low potential voltage higher than the pixel ground voltage ELVSS. The reference voltage Vref may be set to a voltage at which the driving element DT may be turned on. The reference voltage Vref may be set to a voltage within a voltage range of the data voltage Vdata output from the data driver 110. The maximum voltage of the data voltage Vdata may be lower than the pixel driving voltage ELVDD, and the minimum voltage of the data voltage Vdata may be higher than the pixel ground voltage ELVSS.

In the display driving period NDR of the pixel circuit, a one frame period may include an initialization phase INIT, followed by a sampling phase SMPL, followed by an addressing phase WR, and followed by an emission phase EMIS.

The pulse of the first scan signal SC1 may be synchronized with the data voltage Vdata of the pixel data and generated as the gate high voltage VGH during the addressing phase WR. The voltage of the first gate signal SC1 may be the gate low voltage VGL during the initialization phase INIT, the sampling phase SMPL, and the emission phase EMIS. The pulse of the second scan signal SC2 may be generated as the gate high voltage VGH during the initialization phase INIT and the sampling phase SMPL. The voltage of the second scan signal SC2 may be the gate low voltage VGL during the addressing phase WR and the emission phase EMIS. The pulse of the third scan signal SC3 may be generated as the gate high voltage VGH during the initialization phase INIT. The voltage of the third scan signal SC3 may be the gate low voltage VGL during the sampling phase SMPL, the addressing phase WR, and the emission phase EMIS.

The pulse of the first emission signal EM1 may be the gate low voltage VEL during the initialization phase INIT and the addressing phase WR. In other implementations, the pulse of the first emission signal EM1 may be generated as the gate high voltage VEH during the initialization phase INIT. The voltage of the first emission signal EM1 may be the gate high voltage VEH during the sampling phase SMPL and the emission phase EMIS. The pulse of the second emission signal EM2 may be generated as the gate high voltage VEH during the initialization phase INIT and the emission phase EMIS. The voltage of the second emission signal EM2 may be the gate low voltage VEL during the sampling phase SMPL and the addressing phase WR.

Each of the switch elements M1 to M5 may be turned on when the gate high voltage VGH, VEH is applied to its gate electrode, while being turned off when the gate low voltage VGL, VEL is applied to its gate electrode. The driving element DT may be turned on when the gate-source voltage Vgs is higher than the threshold voltage Vth to generate a current according to the gate-source voltage Vgs to drive the light-emitting element EL.

An anode electrode of the light-emitting element EL may be connected to a fourth node n4, and a cathode electrode thereof may be connected to a VSS node to which the pixel ground voltage ELVSS is applied. The VSS node may be connected to a VSS wire VSS.

The driving element DT may include a gate electrode connected to a second node DRG, a first electrode connected to a first node DRD, and a third electrode connected to a third node DRS and may generate a driving current for the light-emitting element EL. A first capacitor C1 may be connected between the second node DRG and the third node DRS. The first capacitor C1 may store the gate-source voltage Vgs of the driving element DT. A second capacitor C2 may be connected between the third node DRS and a VDD node. The VDD node may be connected to the VDD wire VDD to which the pixel driving voltage ELVDD is applied.

A first switch element M1 may be turned on according to the gate high voltage VGH of the first scan signal SC1 to supply the data voltage Vdata to the second node DRG during the addressing phase WR. The first switch element M1 may include a gate electrode connected to a first gate line GL1 to which the first scan signal SC1 is applied, a first electrode connected to a data line DL to which the data voltage Vdata is applied, and a second electrode connected to the second node DRG.

A second switch element M2 may be turned on according to the gate high voltage VGH of the second scan signal SC2 to supply the reference voltage Vref to the second node DRG during the initialization phase INIT and the sampling phase SMPL. The second switch element M2 may include a gate electrode connected to a second gate line GL2 to which the second scan signal SC2 is applied, a first electrode connected to a REF line to which the reference voltage Vref is applied, and a second electrode connected to the second node DRG.

A third switch element M3 may be turned on according to the gate high voltage VGH of the third scan signal SC3 to apply an initialization voltage Vinit to the third node DRS during the initialization phase INIT. The third switch element M3 may include a gate electrode connected to a third gate line GL3 to which the third scan signal SC3 is applied, a first electrode connected to the third node DRS, and a second electrode connected to a power wire to which the initialization voltage Vinit is applied.

A fourth switch element M4 may be turned off according to the gate low voltage VEL of the first emission signal EM1 to block the current path between a VDD line, to which the pixel driving voltage ELVDD is applied, and the first node DRD during the initialization phase INIT and the addressing phase WR. The fourth switch element M4 may be turned on according to the gate high voltage VEH of the first emission signal EM1 to connect the VDD line to the first node DRD during the sampling phase SMPL and the emission phase SMPL. The fourth switch element M4 may include a gate electrode connected to a fourth gate line GL4 to which the first emission signal EM1 is applied, a first electrode connected to the VDD line, and a second electrode connected to the first node DRD.

A fifth switch element M5 may be turned off according to the gate low voltage VEL of the second emission signal EM2 to block the current path between the third node DRS and the fourth node n4 during the sampling phase SMPL and the addressing phase WR. The fifth switch element M5 may be turned on according to the gate high voltage VEH of the second emission signal EM2 to form the current path between the driving element DT and the light-emitting element EL during the initialization phase INIT and the emission phase EMIS. The fifth switch element M5 may include a gate electrode connected to a fifth gate line GL5 to which the second emission signal EM2 is applied, a first electrode connected to the third node DRS, and a second electrode connected to the fourth node n4.

The display driving refers to a driving state in which input image data is written into the pixels of the display panel 100 and an input image is displayed on the display area AA. During the period in which the display driving is performed, that is, during the display driving period NDR, the light-emitting element is turned on by an emission signal that controls the light-emission timing of the light-emitting element, and the input image data is displayed as an image on the display panel 100. Power may be supplied from the host system 300 to the power circuit 140 to drive the driving circuit of the display panel 100 so that pixels may be driven after a power-on sequence.

There are periods of time during which the display driving is not performed, i.e., a display non-driving periods, and during such display non-driving periods, the light-emitting element may be controlled to be in an off state. In this case, an emission signal may be generated as a gate-off voltage to turn off the light-emitting element during a display non-driving period. The emission signal is applied to the gate electrode of the emission switch element of the pixel circuit. Accordingly, when the emission signal is at the gate-off voltage, the emission switch element may be turned off so that no current can flow to the light-emitting element, and thus the light-emitting element may be controlled to be in the off state.

The display non-driving period includes a power-on sequence (Power On) interval from the start of system power up to the start of display driving, and a power-off sequence (Power Off) interval from the end of display driving to the end of system power. The power on sequence interval refers to a period of time from when power is applied from the host system 300 to when the screen is turned on, and the power off sequence interval refers to a period of time from when the screen is turned off to when the system power is released.

The display non-driving period further includes a sleep mode interval in which the display panel 100 is in a state in which the screen of the display panel 100 is turned off while the system power is being applied, i.e., in a state in which display driving is temporarily stopped. Sleep mode may be a mode that is set to temporarily stop the display driving when there is no user input to reduce power consumption, and may be referred to as, for example, but not limited to, standby mode, low power mode, or the like.

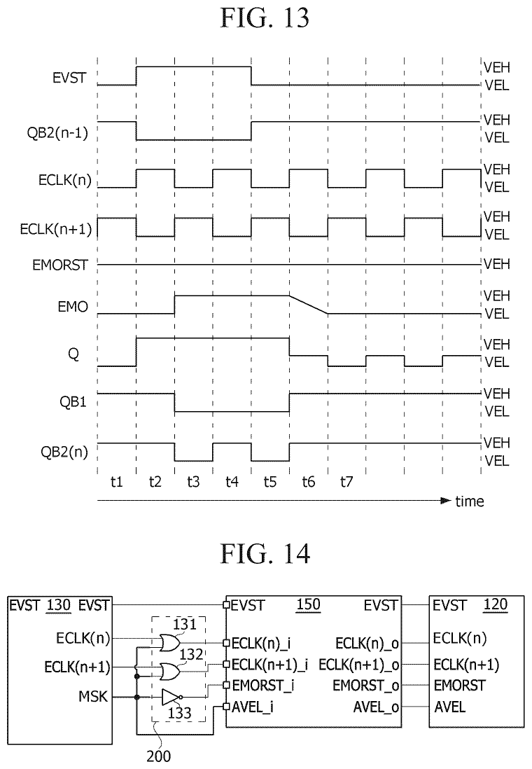

FIG. 12 is a circuit diagram illustrating a circuit of the emission driver according to one example of the present disclosure. The circuit shown in FIG. 12 is an example of a circuit for the (n)th (n is a positive integer) signal transmitting part ST of the emission driver. All of the signal transmitting parts constituting the emission driver may be implemented with the circuit shown in FIG. 12. It should be noted that the circuit of the emission driver is not limited to FIG. 12. FIG. 13 is a waveform diagram illustrating input/output signals and voltages at main nodes for the emission driver shown in FIG. 12.

Referring to FIGS. 12 and 13, each of the signal transmitting parts ST of the emission driver includes a plurality of transistors T1 to T10, Tbv1, Tbv2, and T_RST, and a plurality of capacitors CQ, CQB1, and CQB2. The transistors T1 to T10, Tbv1, Tbv2, and T_RST are illustrated as p-channel transistors, but are not limited thereto. The gate-on voltage and the gate-off voltage may depend on the channel type of the transistors.

The emission driver receives a start signal EVST, a first clock signal ECLK(n), a second clock signal ECLK(n+1), an emission-on signal AVEL, a gate high voltage VEH, a reset signal EMORST, and the voltage QB2(n−1) of a node QB2(n) of a previous signal transmitting part, and outputs the emission signal EMO. The start signal EVST, the first clock signal ECLK(n), the second clock signal ECLK(n+1), the emission-on signal AVEL, and the emission signal EMO may swing between the gate high voltage VEH and the gate low voltage VEL. The gate high voltage VEH may be interpreted as the gate-off voltage. The gate low voltage VEL may be interpreted as the gate-on voltage.

The pulse of the start signal EVST or the pulse of the carry signal CAR output from the previous signal transmitting part may be applied to the input terminal of the signal transmitting part every frame to charge a Q node to the gate-on voltage, such as the gate low voltage. The first clock signal ECLK(n) and the second clock signal ECLK(n+1) are phase-shifted clock signals. The first clock signal ECLK(n) and the second clock signal ECLK(n+1) may occur in opposite phase or delayed phase with each other. The reset signal EMORST is a control signal that serves to selectively discharge the residual charges on the output node. The reset signal EMORST may be maintained at the gate high voltage VEH during the display driving period NDR and may be generated as the gate low voltage VEL during the display non-driving period. The display non-driving period may include a power-on sequence, a power-off sequence, and a sleep mode.

A first transistor T1 electrically connects a VST node to a first N node N1 in response to the gate low voltage VEL of the second clock signal ECLK(n+1). The start signal EVST or the carry signal CAR is input to the VST node. The first transistor T1 includes a gate electrode connected to a second clock node to which the second clock signal ECLK(n+1) is input, a first electrode connected to the VST node, and a second electrode connected to the first N node N1. A second transistor Tbv2 electrically connects a second electrode of the fourth transistor T4 to a second N node N2 in response to the gate low voltage VEL of the emission-on signal AVEL. The second transistor Tbv2 includes a gate electrode connected to a node to which the emission-on signal AVEL is input (hereinafter referred to as the “AVEL node”), a first electrode connected to the second electrode of a fourth transistor T4, and a second electrode connected to the second N node N2.

A third transistor T3 electrically connects the first N node N1 to a gate-off voltage node (hereinafter referred to as the “VEH node”) in response to the gate low voltage VEL of a second QB node QB2(n). The third transistor T3 includes a gate electrode connected to the second QB node QB2(n), a first electrode connected to the first N node N1, and a second electrode connected to the VEH node. The fourth transistor T4 electrically connects a second QB node QB2(n−1) of the previous signal transmitting part to the first electrode of the second transistor Tbv2 in response to the gate low voltage VEL of the second clock signal ECLK(n+1). The fourth transistor T4 includes a gate electrode connected to a second clock node to which the second clock signal ECLK(n+1) is input, a first electrode connected to the second QB node QB2(n−1) of the previous signal transmitting part, and a second electrode connected to the second N node N2. When both the second and fourth transistors Tbv2 and T4) are in an on-state, the second QB node QB2(n−1) of the previous signal transmitting part is electrically connected to the second N node N2.

A fifth transistor T5 electrically connects a first QB node QB1 to the VEH node in response to the gate low voltage VEL of the first N node N1. The fifth transistor T5 includes a gate electrode connected to the first N node N1, a first electrode connected to the first QB node QB1, and a second electrode connected to the VEH node.

A sixth transistor T6 electrically connects the AVEL node to the output node in response to the gate low voltage VEL of the Q node Q. The sixth transistor T6 may be interpreted as a pull-up transistor. During the display driving period NDR, when the sixth transistor T6 is turned on, the pulse of the emission signal EMO that causes the emission switch element of the pixel circuit to be turned on may be output. The sixth transistor T6 includes a gate electrode connected to the Q node Q, a first electrode connected to the AVEL node, and a second electrode connected to the output node. The emission signal EMO may be output via the output node and applied to a gate line connected to the emission switch element in the pixel circuit. For the n-channel transistor-based pixel circuit as shown in FIG. 10, the emission signal EMO may be inverted and applied to the gate electrode of the emission switch element.

A seventh transistor T7 electrically connects the output node to the VEH node in response to the gate low voltage VEL of the first QB node QB1. The seventh transistor T7 may be interpreted as a pull-down transistor. During the display non-driving period, the seventh transistor T7 is maintained in the on-state so that the voltage of the output node is controlled to the gate-off voltage, and thus the emission switch element of the pixel circuit may be maintained in the off state during the display non-driving period. The seventh transistor T7 includes a gate electrode connected to the first QB node QB1, a first electrode connected to the output node, and a second electrode connected to the VEH node.

An eighth transistor T8 electrically connects a first clock node to which the first clock signal ECLK(n) is input to the second QB node QB2(n) in response to the gate low voltage VEL of the second N node N2. The eighth transistor T8 includes a gate electrode connected to the second N node N2, a first electrode connected to the first clock node, and a second electrode connected to the second QB node QB2(n). A ninth transistor T9 electrically connects the second QB node QB2(n) to the first QB node QB1 in response to the gate low voltage VEL of the first clock signal ECLK(n). The ninth transistor T9 includes a gate electrode connected to the first clock node, a first electrode connected to the second QB node QB2(n), and a second electrode connected to the first QB node (QB1).

A tenth transistor T10 electrically connects the second QB node QB2(n) to the VEH node in response to the gate low voltage VEL of the first N node N1. The tenth transistor T10 includes a gate electrode connected to the first N node N1, a first electrode connected to the second QB node QB2(n), and a second electrode connected to the VEH node. An eleventh transistor Tbv1 electrically connects the first N node N1 to the Q node Q in response to the gate low voltage VEL of the emission-on signal AVEL. The eleventh transistor Tbv1 includes a gate electrode connected to the AVEL node to which the emission-on signal AVEL is input, a first electrode connected to the first N node N1, and a second electrode connected to a Q node Q.

A twelfth transistor T_RST electrically connects the output node to the VEH node in response to the gate low voltage VEL of the reset signal EMORST to reset the voltage on the output node to the gate-off voltage. The twelfth transistor T_RST includes a gate electrode connected to a reset signal node to which the reset signal EMORST is input, a first electrode connected to the output node, and a second electrode connected to the VEH node.

A first capacitor CQ is connected between the Q node Q and the first clock node to maintain the gate voltage of the sixth transistor T6. A second capacitor CQB1 is connected between the first QB node QB1 and the VEH node to maintain the gate voltage of the seventh transistor T7. A third capacitor CQB2 is connected between the second N node N2 and the second QB node QB2(n) and is used as a diode connection capacitor allowing the eighth transistor T8 to act as a diode.

An example in which the emission driver normally operates during the display driving period will be described step by step with reference to FIG. 13 as follows. First, in an interval t1, the second clock signal ECLK(n+1) is the gate high voltage VEH, so the first and fourth transistors T1 and T4 are turned off. In this case, the Q node Q becomes floating and maintains the gate low voltage VEL. Therefore, in the interval t1, the sixth transistor T6 is in the on-state.

Since the first clock signal ECLK(n) is at the gate low voltage VEL in the interval t1, the voltage of the first capacitor CQ is not charged in the interval t1. Since the voltage of the second QB node QB2(n−1) of the (n−1)th signal transmitting part and the voltage of the QB2 node QB2(n) of the (n)th signal transmitting part are at the gate high voltage in the interval t1, the third and eighth transistors T3 and T8 are turned off in the interval t1. In the interval t1, the fifth, ninth, and tenth transistors T5, T9, and T10 are turned on, and the seventh transistor T7 is turned off because the first QB node QB1 is at the gate high voltage VEH. In the interval t1, the gate low voltage VEL of the emission-on signal AVEL is output from the output node.

The second clock signal ECLK(n+1) is at the gate low voltage VEL during the interval t2, so the first and fourth transistors T1 and T4 are turned on in an interval t2. In the interval t2, the gate high voltage VEH of the start signal EVST is applied to the Q node Q, so that the voltage at the Q node Q is maintained at the gate high voltage VEH and the sixth transistor T6 is turned off. Furthermore, the gate high voltage VEH of the start signal EVST is applied to the gate electrodes of the fifth and tenth transistors T5 and T10 in the interval t2, causing the fifth and tenth transistors T5 and T10 to turn off. Since the first clock signal ECLK(n) is at the gate high voltage VEH during the interval t2, the ninth transistor T9 is turned off. The first QB node QB1 is at the gate high voltage VEH and the seventh transistor T7 is in the turn-off state in the interval t2. Both the sixth and seventh transistors T6 and T7 are in the off state in the interval t2, and the voltage of the output node is maintained at the gate low voltage VEL.

Since the second clock signal ECLK(n+1) is at the gate high voltage VEH in an interval t3, the first and fourth transistors T1 and T4 are turned off, and the voltage on the Q node Q is maintained at the gate high voltage VEH. Therefore, the sixth transistor T6 is in the off state during the interval t3.

Since the first clock signal ECLK(n) is at the gate low voltage VEL during the interval t3, a potential difference between the gate high voltage VEH and the emission-on signal AVEL is charged in the first capacitor CQ. The first clock signal ECLK(n) is at the gate low voltage VEL in the interval t3, and the eighth and ninth transistors T8 and T9 are turned on, causing the voltage at the first QB node QB1 to change to a gate low voltage VGL. Accordingly, the seventh transistor T7 is turned on in the interval t3, and the gate high voltage VEH is applied to the output node, causing the voltage of the emission signal EMO to be inverted to the gate high voltage VEH.

Since the voltage of the second clock signal ECLK(n+1) is at the gate low voltage VEL in an interval t4, the first and fourth transistors T1 and T4 are turned on, and the gate high voltage VEH of the start signal EVST is applied to the Q node Q, so that the voltage on the Q node Q is at the gate high voltage VEH. The fifth, sixth, and tenth transistors T5, T6, and T10 are in the off state during the interval t4. In the interval t4, the ninth transistor T9 is turned off due to the gate high voltage VEH of the first clock signal ECLK(n). The second QB node QB2(n) is at the gate high voltage VGH in the interval t4. The voltage on the first QB node QB1 is at the gate low voltage VEL in the interval T4, and the seventh transistor T7 is maintained at the on state so that the voltage on the output node is at gate high voltage.

Since the voltage of the second clock signal ECLK(n+1) is at the gate high voltage VEH in an interval t5, the first and fourth transistors T1 and T4 are turned off. The Q node Q becomes floating in the interval t5, so that the voltage on the Q node Q is maintained at the gate high voltage VEH. Therefore, the sixth transistor T6 is maintained at the off state in the interval t5.

Since the voltage of the first clock signal ECLK(n) is at the gate low voltage VEL in the interval t5, the potential difference between the gate high voltage VEH and the emission-on signal AVEL is charged in the first capacitor CQ. Since the voltage of the first clock signal ECLK(n) is at gate low voltage VEL in the interval t5, the eighth and ninth transistors T8 and T9 are turned on to change the voltage on the second QB node QB2(n) to the gate low voltage VEL, and the voltage of the first QB node QB1 is maintained at the gate low voltage. Accordingly, the seventh transistor T7 remains the turn-on state so that the gate high voltage VEH is output to the output node.

Since the voltage of the second clock signal ECLK(n+1) is at the gate low voltage VEL in an interval t6, the first and fourth transistors T1 and T4 are turned on, so that the gate low voltage of the start signal EVST is passed to the Q node Q, thereby reducing the voltage of the Q node Q to the gate low voltage VEL. The sixth transistor T6 is turned on in response to the gate low voltage VEL of the Q node Q in the interval t6.

Since the voltage of the first clock signal ECLK(n) is at the gate high voltage VEH in the interval t6, the first capacitor CQ is charged with the potential difference between the emission-on signal AVEL and the gate high voltage VEH. Since the voltages on the first QB node QB2(n−1) of the (n−1)th signal transmitting part QB2(n) and the second QB node QB2(n) of the (n)th signal transmitting part QB2(n) are at the gate high voltage VEH in the interval t6, the third and eighth transistors T3 and T8 are turned off. In the interval t6, the fifth and tenth transistors T5 and T10 are turned on and the ninth transistor T9 is turned off, so that the voltage on the first QB node QB1 is at the gate high voltage VEH. Therefore, the seventh transistor T7 is turned off in the interval t6, and the voltage of the emission signal EM0 output via the output node is reduced from the gate high voltage VEH to the gate low voltage VEL.

Since the voltage of the second clock signal ECLK(n+1) is at the gate high voltage VEH in an interval t7, the first and fourth transistors T1 and T4 are turned off, the Q node Q becomes floating, and the voltage on the Q node Q is at the gate low voltage VEL. Therefore, the sixth transistor T6 is in the on state in the interval t7.

The third, eighth, and ninth transistors T3, T8, and T9 are in the off state in the interval t7, and the fifth and tenth transistors T5 and T10 are in the on state. The voltage on the first QB node QB is at the gate high voltage VEH in the interval t7, and the seventh transistor T7 is in the off state. Therefore, in the interval t7, the voltage of the emission signal EM0 output from the output node is the same gate low voltage VEL as the emission-on signal AVEL.

For example, when the pulses of the clock signals ECLK(n+1) and ECLK(n) are output repeatedly during the display non-driving period, such as the power-on sequence interval Power ON, sleep mode interval Sleep Mode, and power-off sequence interval Power OFF, the voltages on the clock nodes swing repeatedly between the gate high voltage VEH and the gate low voltage VEL during the display non-driving period, causing the first transistor T1 to repeatedly turn on and off. During the display non-driving period, when the first transistor T1 is repeatedly turned on and off, the potential of the Q node Q may fluctuate unstably, causing the sixth transistor T6 to turn on. Then, the sixth and seventh transistors T6 and T7 may turn on simultaneously within the display non-driving period, causing the sixth and seventh transistors T6 and T7 to short circuit and an inrush current to occur. In this case, the PMIC with the integrated power circuit may be shut down during the display non-driving period, causing the pixels on the display panel not to be driven during the subsequent display driving period, resulting in the screen turning off. In the example of the present disclosure, as shown in FIGS. 14 to 18, the start signal EVST and the clock signals ECLK(n+1) and (ECLK(n)) input to the emission driver during the display non-driving period are controlled by the gate-off voltage. Consequently, since no pulses are output from the emission driver during the display non-driving period, no power is consumed, preventing the sixth and seventh transistors T6 and T7 from short-circuiting and the power circuit from abnormally shutting down.

FIG. 14 is a circuit diagram illustrating a masking circuit according to one example of the present disclosure. In FIG. 14, ECLK(n)_i, ECLK(n+1)_i, EMORST_i, and AVEL_i are the clock signals, the reset signal, and the emission-on signal of the gate timing control signal GSC input to the level shifter 150. The gate timing control signals EVST, ECLK(n)_i, ECLK(n+1)_i, EMORST_i, and AVEL_i input to the level shifter are digital signals that swing between a low level (L) and a high level (H) of the voltage of the digital signal voltage. The voltages of the digital signals are lower than the voltages of the gate timing signals EVST, ECLK(n)_o, ECLK(n+1)_o, EMORST_o, AVEL_o output from the level shifter 150. The voltages of the gate timing signals EVST, ECLK(n)_o, ECLK(n+1)_o, EMORST_o, AVEL_o output from the level shifter 150 swing between the gate low voltage VEL and the gate high voltage VEH.

The timing controller 130 may mask at least one signal selected from the gate timing control signal GSC during the display non-driving period in response to the light-emission enable signal EL_EN input from the host system 300. For example, the timing controller 130 may either mask the start signal EVST as the high-level signal or mask both the start signal EVST and the clock signals ECLK(n) and ECLK(n+1) as the high-level signal during the display non-driving period in response to the voltage having a specific logic level, such as a low level (L), of the light-emission enable signal EL_EN provided during the display non-driving period.

In the example shown in FIG. 14, the start signal EVST is masked by the timing controller 130 during the display non-driving period and the clock signals ECLK(n) and ECLK(n+1) are masked by the masking circuit 200, but are not limited thereto. For example, the masking circuit 200 may be embedded in the logic circuit of the timing controller 130, so that both the start signal EVST and the clock signals ECLK(n) and ECLK(n+1) may be masked by the timing controller 130 during the display non-driving period.

Referring to FIG. 14, the timing controller 130 controls the voltage of the start signal EVST input to the emission driver to the gate-off voltage, such as the gate high voltage VEH, in response to the voltage having a specific logic level, such as a low level (L), of the light-emission enable signal EL_EN input from the host system 300 during the display non-driving period. The voltage of the start signal EVST input from the timing controller 130 to the level shifter 150 may be maintained at the high level (H) during the display non-driving period period, and the level shifter 150 may convert the high level voltage of the start signal EVST to the gate-off voltage, such as the gate high voltage VEH, to provide the converted voltage to the emission driver. As a result, the start signal EVST input to the emission driver may be held at the gate-off voltage during the entire display non-driving period, for example, during the power-on sequence interval Power ON, sleep mode interval Sleep Mode, and power-off sequence interval Power OFF. On the other hand, the start signal EVST is repeatedly output as the pulse that swings between the gate-on and gate-off voltages during the display driving period NDR.

When the start signal EVST is input to the emission driver as the pulse of the gate-on voltage, the emission driver may output the pulse of the emission signal. Accordingly, when the start signal EVST is held at the gate-off voltage during the display non-driving period, the emission driver does not output a pulse of the gate-on voltage during the display non-driving period.

The timing controller 130 may generate a masking signal MSK to control the voltage of the clock signals ECLK(n) and ECLK(n+1), which are input to the emission driver, to the gate-off voltage during at least a portion of the display non-driving period.

The emission-on signal AVEL may originate from the masking signal MSK and input to the emission driver as the voltage that is in-phase with the masking signal MSK and greater than the masking signal MSK. For example, when the voltage of the masking signal MSK output from the timing controller 130 is at a low level (L) of the digital signal, the voltage of the emission-on signal AVEL_i input to the level shifter 150 may be at a low level (L) and the voltage of the emission-on signal AVEL_i output from the level shifter 150 may be at a gate low voltage VEL. On the other hand, when the voltage of the masking signal MSK is at a high level (H) of the digital signal, the voltage of the emission-on signal AVEL_i input to the level shifter 150 may be at a high level (H) and the emission-on signal AVEL_i output from the level shifter 150 may be at a gate high voltage VEH.

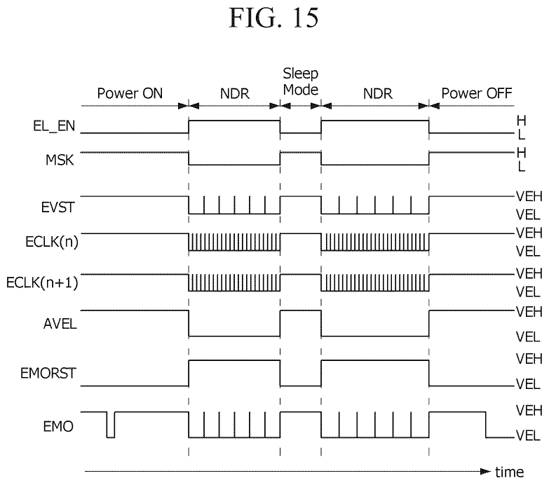

The timing controller 130 may invert the light-emission enable signal EN_EL to output it as the masking signal MSK. For example, as shown in FIGS. 15, 17, and 18, the voltage of the light-emission enable signal EN_EL input to the timing controller 130 may be at a low level (L) during the display non-driving period and at a high level (H) during the display driving period NDR. In this case, the timing controller 130 may invert the light-emission enable signal EN_EL to output it as the masking signal MSK that is at a high level (H) during the display non-driving period and at a low level (L) during the display driving period NDR.

The masking signal MSK output from the timing controller 130 is input to the level shifter 150 as an emission-on signal AVEL. The level shifter 150 level-shifts the voltage of the emission-on signal AVEL to supply it to the emission driver.

The display device may further include the masking circuit 200. The masking circuit 200 may be connected between the timing controller 130 and the level shifter 150, but is not limited thereto. The masking circuit 200 changes the clock signals ECLK(n) and ECLK(n+1) input from the timing controller 130 according to the masking signal MSK and outputs them to the level shifter 150, and generates the reset signal EMORST as an inverted signal of the masking signal MSK and outputs it to the level shifter 150.

The masking circuit 200 controls the voltage of the clock signals ECLK(n)_i and ECLK(n+1)_i input to the level shifter 150 to a high level (H) during at least a portion of the display non-driving period. The level shifter 150 converts the high-level voltage of the clock signal ECLK(n)_i and ECLK(n+1)_i input from the masking circuit 200 to the gate-off voltage, such as the gate high voltage VEH, and converts the low-level voltage to the gate-on voltage, such as the gate low voltage VEL.

The masking circuit 200 may control the voltage of the clock signals ECLK(n)_i and ECLK(n+1)_i input to the level shifter 150 to a high level (H) during at least a portion of the display non-driving period by using logic elements, such as a plurality of logic OR gates 131 and 132. For example, the voltage of the masking signal MKS may be at a high level (H) during the display non-driving period and at a low level (L) during the display driving period NDR. In this case, the OR gates 131 and 132 output the logical sum of the input clock signals ECLK(n) and ECLK(n+1) and the masking signal MKS. As a result, the voltages of the clock signals ECLK(n)_i and ECLK(n+1)_i, which are output from the masking circuit 200 and input to the level shifter 150 during the display non-driving period, are at a high level (H) equal to the masking signal MSK, regardless of the digital signal level of the input clock signals ECLK(n) and ECLK(n+1)_i. On the other hand, because the voltage of the masking signal MSK is held at a low level (L) during the display driving period NDR, the voltages of the clock signals ECLK(n)_i and ECLK(n+1)_i, which are output from the masking circuit 200 and input to the level shifter 150 during the display driving period NDR, are at the voltage of the clock signal synchronized with the input clock signals ECLK(n) and ECLK(n+1).

The voltage of the reset signal EMORST may be generated as a digital signal in inverse phase with respect to the masking signal MSK. The masking circuit 200 may generate the reset signal EMORST_i by using a NOT gate 133 that serves to invert the masking signal MSK. For example, when the voltage of the masking signal MSK output from the timing controller 130 is at a low level (L) of the digital signal, the voltage of the reset signal EMORST_i input to the level shifter 150 from the masking circuit 200 may be at a high level (H) and the voltage of the reset signal EMORST_o output from the level shifter 150 may be at a gate high voltage VEH, as shown in FIGS. 14 and 15. On the other hand, when the voltage of the masking signal MSK is at a high level (H), the voltage of the reset signal EMORST_i input to the level shifter 150 from the masking circuit 200 may be at a low level (L) and the voltage of the reset signal EMORST_o output from the level shifter 150 may be at a gate low voltage VEL.

As can be seen in FIG. 12 and FIG. 15, during the display non-driving period, the voltages on the VST node, the first clock node, and the second clock node are held at the gate-off voltage. In contrast, during the display driving period NDR, a plurality of pulses that swing between the gate-off voltage and the gate-on voltage are input to the VST node, the first clock node, and the second clock node. The voltage of the emission-on signal AVEL is held at said gate-off voltage during the display non-driving period and is maintained at said gate-on voltage during the display driving period NDR. The voltage of the reset signal EMORST is held at the gate-on voltage during the display non-driving period and is held at the gate-off voltage during the display driving period NDR. The voltage of the emission signal EMO is held at the gate-off voltage during the display non-driving period. The emission signal EMO includes a plurality of pulses that swing between the gate-off voltage and the gate-on voltage during the display driving period NDR.

FIG. 15 is a waveform diagram illustrating a method of controlling the emission driver according to one example of the present disclosure.

Referring to FIG. 15, the masking signal MSK may be generated as a digital signal in inverse phase with respect to the light-emission enable signal EL_EN. For example, the light-emission enable signal EL_EN may be generated at the low level (L) during the display non-driving period in which the pixels are not driven, while it may be generated at the high level (H) during the display driving period in which the pixels are driven and the input image is reproduced on the display area AA. The display non-driving period during which masking processing is applied include the power-on sequence interval Power ON, sleep mode interval Sleep Mode, and power-off sequence interval Power OFF. In this case, the masking signal MSK may be generated at the high level (H) voltage during the power-on sequence interval Power ON, sleep mode interval Sleep Mode, and power-off sequence interval Power OFF, while it may be generated at the low level (L) voltage during the display driving period NDR.

The emission-on signal AVEL may be generated in phase with the masking signal MSK, and the reset signal EMORST may be generated in inverse phase with respect to the masking signal MSK. The masking signal MSK may be generated at the high level (H) voltage during the power-on sequence interval Power ON, sleep mode interval Sleep Mode, and power-off sequence interval Power OFF, while it may be generated at the low level (L) voltage during the display non-driving period. In this case, the emission-on signal AVEL may be generated at the gate high voltage VEH corresponding to the high level (H) during the power-on sequence interval Power ON, sleep mode interval Sleep Mode, and power-off sequence interval Power OFF, while it may be generated at the gate low voltage VEL corresponding to the low level (L) during the display driving period NDR. The reset signal EMORST may be generated at the gate low voltage VEL corresponding to the low level (L) during the power-on sequence interval Power ON, sleep mode interval Sleep Mode, and power-off sequence interval Power OFF, while it may be generated at the gate high voltage VEH corresponding to the high level (H) during the display driving period NDR.

The voltage of the start signal EVST and the clock signals ECLK(n) and ECLK(n+1) input to the emission driver is at the gate high voltage VEH, which is the gate-off voltage during the power-on sequence interval Power ON, sleep mode interval Sleep Mode, and power-off sequence interval Power OFF On the other hand, the start signal EVST and the clock signals ECLK(n) and ECLK(n+1) input to the emission driver may include two or more pulses that swing between the gate high voltage VEH and the gate low voltage VEL during the display driving period NDR.

The voltage of the emission signal EMO output from the emission driver is at the gate high voltage VEH, which is the gate-off voltage during the power-on sequence interval Power ON, sleep mode interval Sleep Mode, and power-off sequence interval Power OFF. On the other hand, the voltage of the emission signal EMO may include two or more pulses that swing between the gate high voltage VEH and the gate low voltage VEL during the display driving period NDR.

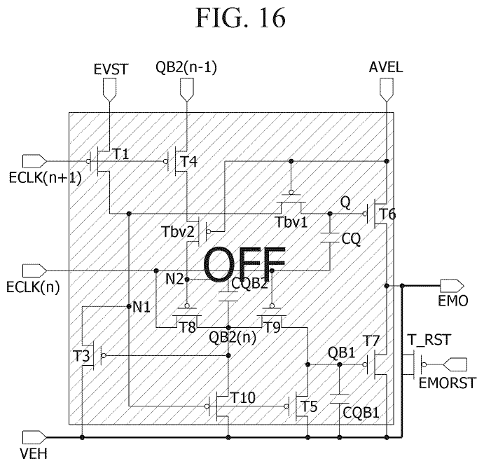

FIG. 16 is a circuit diagram illustrating an operation of the emission driver during a masking interval according to one example of the present disclosure. The masking interval may be the high level (H) interval of the masking signal MSK set during the display non-driving period.

Referring to FIG. 16, during the masking interval, the voltages of the start signal EVST, the clock signals ECLK(n) and ECLK(n+1), and the emission-on signal AVEL are controlled as the gate high voltage VEH, which is the gate-off voltage, and the reset signal EMORST is controlled as the gate low voltage VEL, which is the gate-on voltage. As a result, in the emission driver, the first transistor T1 is maintained at the off state during the masking interval, which prevents voltage fluctuations from occurring at the Q node Q and prevents short circuits from occurring between the sixth and seventh transistors T6 and T7. During the masking interval, the twelfth transistor T_RST may turn on in response to the reset signal EMORST to suppress the voltage of the emission signal EMO to the gate-off voltage, e.g., the gate high voltage VEH. As a result, it is possible to prevent shutdown failure and malfunction of the power circuit and the display panel driving circuit due to inrush current during the power-on sequence interval Power ON, sleep mode interval Sleep Mode, and power-off sequence interval Power OFF.

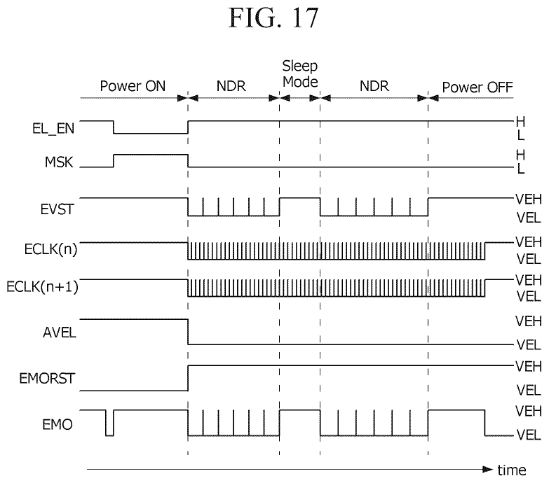

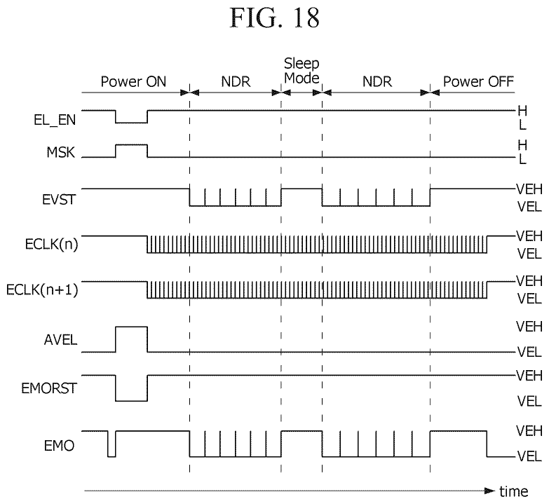

The masking interval may be set in a portion of the display non-driving period rather than the entirety of the display non-driving period. For example, as shown in FIGS. 17 and 18, the masking interval set at an on-level, such as the high level (H), of the masking signal MSK, may be applied only to at least a portion of the power-on sequence interval Power ON. In this case, the host system may generate the voltage of the light-emission enable signal EN_EL as an off-level, e.g., the low level (L), only during at least a portion of the power-on sequence interval Power ON.

For example, the masking interval may be set only during the power-on sequence interval Power ON, as shown in FIG. 17, or may be set during the initial some portion of the power-on sequence interval Power ON, as shown in FIG. 18. In the examples of FIGS. 17 and 18, since pulses of the start signal EVST and the clock signals ECLK(n) and ECLK(n+1) are normally generated during the sleep mode interval Sleep Mode, power off sequence interval Power OFF, and display driving period NDR, the pulse of the emission signal may be generated from the emission driver.

The operation of the main nodes and the transistors of the emission driving circuit during the power-on sequence interval Power ON is more unstable than during the sleep mode interval and the power-off sequence interval POWER OFF. In the examples of FIG. 17 and FIG. 18, since the start signal EVST and the clock signal ECLK(n), ECLK(n+1) are not masked in the sleep mode interval and the power-off sequence interval Power OFF, the emission driver may secure a pre-running interval in preparation for its wake-up in the sleep mode interval Sleep Mode, and may obtain the effect of discharging the remaining charge in an emission signal generation circuit owing to the continuous operating of the clock signals in the power-off sequence interval Power OFF.

Within the display driving period NDR, a vertical blank period with no pixel data for each frame period may be controlled by the masking interval. In this case, the power consumption of the display device may be further reduced.

The display device according to an example of the present disclosure may be applied to a mobile device, a video phone, a smart watch, a watch phone, a wearable apparatus, a foldable apparatus, a rollable apparatus, a bendable apparatus, a flexible apparatus, a curved apparatus, a sliding apparatus, a variable apparatus, an electronic notebook, an electronic book, a portable multimedia player (PMP), a personal digital assistant (PDA), an MP3 player, a mobile medical device, a desktop PC, a laptop PC, a netbook computer, a workstation, a navigation system, a vehicle display device, a theater display device, a television, a wallpaper device, a signage device, a game device, a notebook, a monitor, a camera, a camcorder, a home appliance, and the like. In addition, the display device according to one or more examples of the present disclosure may be applied to an organic light-emitting lighting device or an inorganic light-emitting lighting device.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gate driving circuit comprising a plurality of cascade-connected signal transmitting parts, wherein an (n)th signal transmitting part includes:
a plurality of nodes including:
a start signal node to which a start signal or a carry signal from an (n−1)th signal transmitting part is input;
a first clock node to which a first clock signal is input; and
a second clock node to which a second clock signal is input;
a circuit including a plurality of transistors and a plurality of capacitors electrically connected to the start signal node, the first clock node, and the second clock node,
wherein, during a display non-driving period, a respective voltage on each of the start signal node, the first clock node, and the second clock node is maintained at a gate-off voltage, and
wherein, during a display driving period, a respective plurality of pulses that swing between the gate-off voltage and a gate-on voltage is input to each of the start signal node, the first clock node, and the second clock node.

2. The gate driving circuit of claim 1, wherein the plurality of nodes of the (n)th signal transmitting part further includes:
a gate-off voltage node to which the gate-off voltage is applied;
an emission-on signal node to which an emission-on signal is input;
an output node from which an emission signal is output; and
a reset signal node to which a reset signal is input,
wherein a voltage of the emission-on signal is:
maintained at the gate-off voltage during the display non-driving period, and
maintained at the gate-on voltage during the display driving period.

3. The gate driving circuit of claim 2, wherein a voltage of the reset signal is:
maintained at the gate-on voltage during the display non-driving period, and
maintained at the gate-off voltage during the display driving period.

4. The gate driving circuit of claim 2, wherein the voltage of the emission signal is maintained at the gate-off voltage during the display non-driving period, and
wherein the emission signal includes a plurality of pulses that swing between the gate-off voltage and the gate-on voltage during the display driving period.

5. The gate driving circuit of claim 2, wherein the plurality of transistors of the (n)th signal transmitting part includes:
a first transistor configured to electrically connect the start signal node to a first N node in response to the gate-on voltage of the second clock signal;
a second transistor configured to turn on in response to the gate-on voltage of the emission-on signal;
a third transistor configured to electrically connect the first N node to the gate-off voltage node in response to the gate-on voltage on a second QB node;
a fourth transistor configured to turn on in response to the gate-on voltage of the second clock signal;
a fifth transistor configured to electrically connect a first QB node to the gate-off voltage node in response to the gate-on voltage on the first N node;
a sixth transistor configured to electrically connect the emission-on signal node to the output node in response to the gate-on voltage on a Q node; and
a seventh transistor configured to electrically connect the output node to the gate-off voltage node in response to the gate-on voltage on the first QB node;
an eighth transistor configured to electrically connect the first clock node to the second QB node in response to the gate-on voltage on the second N node;
a ninth transistor configured to electrically connect the second QB node to the first QB node in response to the gate-on voltage of the first clock signal;
a tenth transistor configured to electrically connect the second QB node to the gate-off voltage node in response to the gate-on voltage on the first N node,
wherein a second QB node of the (n−1)th signal transmitting part is electrically connected to the second N node when the second transistor and the fourth transistor are turned on.

6. The gate driving circuit of claim 5, wherein the plurality of transistors of the (n)th signal transmitting part includes:
an eleventh transistor configured to electrically connect the first N node to the Q node in response to a gate-on voltage of the emission-on signal; and
a twelfth transistor configured to electrically connect the output node to the gate-off voltage node in response to a gate-on voltage of the reset signal.

7. The gate driving circuit of claim 5, wherein the plurality of capacitors of the (n)th signal transmitting part includes:
a first capacitor connected between the Q node and the first clock node;
a second capacitor connected between the first QB node and the gate-off voltage node; and
a third capacitor connected between the second N node and the second QB node.

8. A display device, comprising:
a display panel including a plurality of pixels, a plurality of gate lines connected to the plurality of pixels, and a gate driving circuit connected to the plurality of gate lines; and
a controller configured to:
receive a light-emission enable signal; and
in response, output a start signal, a first clock signal, a second clock signal, and a masking signal to control the gate driving circuit,
wherein each of the plurality of pixels includes:
a light-emitting element; and
an emission switch transistor configured to turn on in response to a gate-on voltage on one of the plurality of gate lines to form a current path to the light-emitting element,
wherein the gate driving circuit includes an emission driver including a plurality of cascade-connected signal transmitting parts to sequentially output an emission signal onto each of the plurality of gate lines,
wherein an (n)th signal transmitting part of the emission driver includes:
a plurality of nodes including:
a start signal node to which the start signal or a carry signal from an (n−1)th signal transmitting part is input;
a first clock node to which the first clock signal is input; and
a second clock node to which the second clock signal is input; and
a circuit including a plurality of transistors and a plurality of capacitors electrically connected to the start signal node, the first clock node, and the second clock node,
wherein, during a display non-driving period in which the plurality of pixels is not driven, a respective voltage on each of the start signal node, the first clock node, and the second clock node is maintained at a gate-off voltage, and
wherein, during a display driving period in which the plurality of pixels is driven, a respective plurality of pulses that swing between the gate-off voltage and the gate-on voltage is input to each of the start signal node, the first clock node, and the second clock node.

9. The display device of claim 8, wherein the controller is configured to output an inverse signal of the light-emission enable signal as the masking signal.

10. The display device of claim 8, further comprising:
a level shifter configured to level-shift a respective voltage of each of the start signal, the first clock signal, and the second clock signal input from the controller and output it to the emission driver.

11. The display device of claim 10, further comprising:
a masking circuit connected between the controller and the level shifter, the masking circuit being configured to:
change each of the first clock signal and the second clock signal input from the controller according to the masking signal and output it to the level shifter; and
generate a reset signal as an inverse signal of the masking signal and output it to the level shifter.

12. The display device of claim 11, wherein the level shifter is configured to:
level-shift a voltage of the reset signal input from the controller and output it to the emission driver; and
level-shift a voltage of the masking signal to output an emission-on signal, and
wherein the emission-on signal is in phase with the masking signal and has a voltage greater than the masking signal.

13. The display device of claim 12, wherein the plurality of nodes of the (n)th signal transmitting part further includes:
a gate-off voltage node to which the gate-off voltage is applied;
an emission-on signal node to which the emission-on signal is input;
an output node from which the emission signal is output; and
a reset signal node to which the reset signal is input,
wherein the voltage of the emission-on signal is:
maintained at the gate-off voltage during the display non-driving period, and
maintained at the gate-on voltage during the display driving period.

14. The display device of claim 13, wherein the voltage of the reset signal is:
maintained at the gate-on voltage during the display non-driving period, and maintained at the gate-off voltage during the display driving period.

15. The display device of claim 13, wherein a voltage of the emission signal is maintained at the gate-off voltage during the display non-driving period, and wherein the emission signal includes a plurality of pulses that swing between the gate-off voltage and the gate-on voltage during the display driving period.

16. The display device of claim 13, wherein the plurality of transistors of the (n)th signal transmitting part includes:
a first transistor configured to electrically connect the start signal node to a first N node in response to the gate-on voltage of the second clock signal;
a second transistor configured to turn on in response to the gate-on voltage of the emission-on signal;
a third transistor configured to electrically connect the first N node to the gate-off voltage node in response to the gate-on voltage on a second QB node;
a fourth transistor configured to turn on in response to the gate-on voltage of the second clock signal;
a fifth transistor configured to electrically connect a first QB node to the gate-off voltage node in response to the gate-on voltage on the first N node;
a sixth transistor configured to electrically connect the emission-on signal node to the output node in response to the gate-on voltage on a Q node;
a seventh transistor configured to electrically connect the output node to the gate-off voltage node in response to the gate-on voltage on the first QB node;
an eighth transistor configured to electrically connect the first clock node to the second QB node in response to the gate-on voltage on a second N node;
a ninth transistor configured to electrically connect the second QB node to the first QB node in response to the gate-on voltage of the first clock signal; and
a tenth transistor configured to electrically connect the second QB node to the gate-off voltage node in response to the gate-on voltage on the first N node,
wherein a second QB node of the (n−1)th signal transmitting part is electrically connected to the second N node when the second transistor and the fourth transistor are turned on.

17. The display device of claim 16, wherein the plurality of transistors of the (n)th signal transmitting part further includes:
an eleventh transistor configured to electrically connect the first N node to the Q node in response to the gate-on voltage of the emission-on signal; and
a twelfth transistor configured to electrically connect the output node to the gate-off voltage node in response to a gate-on voltage of the reset signal.

18. The display device of claim 16, wherein the plurality of capacitors of the (n)th signal transmitting part includes:
a first capacitor connected between the Q node and the first clock node;
a second capacitor connected between the first QB node and the gate-off voltage node; and
a third capacitor connected between the second N node and the second QB node.

19. The display device of claim 8, wherein the display non-driving period includes a power-on sequence interval, a sleep mode interval, and a power-off sequence interval.

20. The display device of claim 8, wherein the display non-driving period includes at least a portion of a power-on sequence interval.

21. An emission driver comprising a plurality of signal transmitting parts cascade-connected together to sequentially output an emission signal from each signal transmitting part in response to a start signal input to a first signal transmitting part,
wherein an (n)th signal transmitting part includes:
a plurality of nodes including:
a start signal node to which the start signal or a carry signal from an (n−1)th signal transmitting part is input;
an output node from which the emission signal is output, which is input to a start signal node of an (n+1)th signal transmitting part;
a first clock node to which a first clock signal is input, which is input to a second clock node of the (n−1)th signal transmitting part;
a second clock node to which a second clock signal is input, which is input to a first clock node of the (n+1)th signal transmitting part; and
an input node to which a second QB node of the (n−1)th signal transmitting part is electrically connected; and
a circuit including a plurality of transistors and a plurality of capacitors electrically connected between the plurality of nodes, the circuit having a Q node, a first QB node, and a second QB node to which an input node of the (n+1)th signal transmitting part is electrically connected.
